(19) United States
(12) Patent Application Publication
(10) Pub. No.: US 2015/0019292 A1
(43) Pub. Date: Jan. 15, 2015

(54) METHOD AND SYSTEM FOR CREATING CUSTOM ONLINE MARKETPLACES

(71) Applicants: Juuso Tuomas Myllyrinne, New York, NY (US); Richard Charlton Roberts, IV, New York, NY (US)

(72) Inventors: Juuso Tuomas Myllyrinne, New York, NY (US); Richard Charlton Roberts, IV, New York, NY (US)

(21) Appl. No.: 14/326,253

(22) Filed: Jul. 8, 2014

Related U.S. Application Data
(60) Provisional application No. 61/844,258, filed on Jul. 9, 2013.

(51) Int. Cl. G06Q 30/06; G06Q 30/02

(52) U.S. Cl. CPC G06Q 30/0601; G06Q 30/0203; G06Q 30/0641
USPC 705/7.32

(57) ABSTRACT

A method and system for generating a variety of distinct and different custom-online-marketplaces (COMs) is described and disclosed. Such a system may comprise: a server, a server-module, a questionnaire, a generation-script, and a configuration-file. The server may be in communication with a wide-area-network (WAN). The server-module may be running on the server. The questionnaire may be displayable at a URL (domain name) associated with the method. The questionnaire may be an interactive-web-form. An operator may access the URL via an electronic-device in communication with the WAN. The generation-script of the server-module may receive answers and selections of the questionnaire. The configuration-file may be generated by the generation-script processing the answers and the selections from the questionnaire. The server-module may generate the COM by the server-module executing the configuration-file. The created COM may comprise the configuration-file, a graphical-user-interface (GUI), and a database. Sellers and Buyers may transact on the created COM.

### PRIORITY NOTICE

The present application claims priority under 35 U.S.C. §119(e) to U.S. Provisional Patent Application Ser. No. 61/844,258 filed on Jul. 9, 2013, the disclosure of which is incorporated herein by reference in its entirety.

### STATEMENT REGARDING FEDERAL SPONSORSHIP

No part of this invention was a result of any federally sponsored research.

### TECHNICAL FIELD OF THE INVENTION

The present invention relates specifically to methods and systems for generating a variety of distinct and functionally different custom online marketplaces, wherein once such a distinct custom online marketplace may be generated, buyers and sellers may then transact in goods and/or services particular to the generated distinct custom online marketplace.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

To understand a need for a method and/or a system for generating a variety of distinct and functionally different custom online marketplaces (hereinafter, “COMs”), one must first understand what a COM may be.

First it may help to understand a difference between a marketplace and a store as used herein. A marketplace may have three parties: an operator, a seller and a buyer. Ebay.com® may be an example of a marketplace (of a non-custom or non-specialized marketplace); wherein the corporate entity of Ebay.com® may be the operator. Sellers may upload information of their goods for sale to Ebay.com®, buyers may then select and buy the good, and Ebay.com® facilitates the transaction and keeps records of past transactions. Whereas, Bestbuy® may be an example of a store (a retail store, with both an online and offline presence). With Bestbuy® there may be only two parties in transactions: the buyer and the seller (Bestbuy®). With a store, the operator and the seller functions may collapse onto each other and merge.

A custom marketplace may be a marketplace that specializes in matching buyers and sellers around a certain category of goods (products), services, or both. A real-estate agent is a good example of an operator of a custom marketplace (that may be online and/or offline). The real estate agent operates the marketplace, connecting buyers and sellers around one category of products—real estate. A COM may be a custom marketplace wherein the marketplace is online, i.e. wherein the marketplace may be viewed and interacted with via websites and/or mobile applications. A COM might also be known as a “specialized online marketplace” or a “particular online marketplace.”

A general marketplace in contrast, may be an opposite type of marketplace from a COM. In a general marketplace, including online ones, the marketplace may offer essentially anything to anybody, e.g. Craigslist® and Ebay.com®. The reason why many custom marketplaces, including COMs, may be successful, is that custom marketplaces may cater the browsing and transactional experience around a particular niche, i.e. a particular good, service, or both. Custom marketplaces do not offer anything to anybody. For example if one has a custom marketplace that matches dog walkers with dog owners—all the information provided within that custom marketplace may be centered around and focused on that specific market of dog walking. So dog walkers would be able to disclose what types of dogs they have experience with, what pets they have themselves, pictures of dog walking routes they typically take dogs on, and so forth. Such information may make the custom marketplace an experience better for both buyers and sellers compared to unstructured information provided in a general marketplace, e.g. like Craigslist®, where it may be strictly the sellers responsibility to input all the relevant information into an advertisement (posting) on Craigslist®. And buyers know they will have an increased search cost to find what they may be looking for in a general marketplace.

Some examples of markets that may support viable COMs may include markets centered around various particular goods and/or services. For example, COMs may be created and centered around such goods as: real-estate (sales and/or rentals), books, clothes, crafts, electronics, art, toys, pet products, and the like. For example, COMs may be created and centered around location based services such as: personal training, music lessons, college tutoring, massaging, renovations, restaurant reservations, cooking and catering, moving, plumbing, electricians, lawn mowing, wedding planning, interior designing, haircutting, promotional staffing, pet sitting, pet washing, pet walking, cleaning services (maid services), temp workers, and the like. For example, COMS may be created and centered around non-location based services, such as: accounting, legal services, designers, coding/programming, writing, advertising services, headhunting, translation services, consulting, recipes, and the like.

Some examples of existing COMs may be: AirBNB®, Etsy®, Uber®, Seamless®, ZocDoc®, and Sharedesk®. Note, each of these COMs was likely created using coding/programming that was custom and independent of the coding/programming being employed to create the other COMs listed here. It would have been desirable if the operators of each of these COMs could have instead turned to a single turnkey platform of a method and/or a system that could render the desired COM; rather than having to hire and employ custom coders/programmers to create the COM from the ground up, which may be both cost prohibitive and excessively time consuming to build the COM from the ground up.

Additionally, custom marketplaces, including COMs, may also employ a diversity of different business logic for transactions. For example, one might want to pay a dog walker only after the dog walker has completed each walk or alternatively on a weekly or monthly basis. Whereas, a COM that may match personal trainers with clients, may have a business logic supporting the personal trainer selling packages of a certain number of sessions, e.g. a package of 10 sessions, wherein the personal trainer may be paid upon sale of the package, but before the personal trainer does any training for that client who made the package purchase. Thus, it may be desirable for a method and/or a system of generating COMs to be able to implement such a diversity of business logic for various transactions.

In comparison, the general marketplace may generally only support one type of business logic irrespective of the category of goods (products) or services sold. For example, Craigslist® has no inherent infrastructure in place to set up different business logic regimes for different marketplaces.

Currently, in order to create a COM, the prospective operator must build the COM from the ground up, using custom coding/programming. Such custom coding/programming is expensive and time consuming. It would be desirable if instead a prospective operator could use a turnkey method and/or a system for generating a COM, wherein the prospective operator does not have to engage in expensive and time consuming custom coding/programming in order to create the COM.

There is a need in the art for a method and/or system of creating COMs, wherein a need to use custom coding/programming may be mitigated or altogether eliminated. There is a need in the art for a method and/or system of creating COMs, wherein the method and/or system may be flexible to support a variety of different business logics that may applied to a given created COM.

It is to these ends that the present invention has been developed.

### BRIEF SUMMARY OF THE INVENTION

To minimize the limitations in the prior art, and to minimize other limitations that will be apparent upon reading and understanding the present specification, the present invention describes a method and a system for generating a variety of distinct and functionally different custom-online-marketplaces (COMs).

Such a system may comprise: a server, a server-module, a questionnaire, a generation-script, and a configuration-file. The server may be in communication with a wide-area-network (WAN), such as the internet. The server-module may be running on the server. The server-module may be non-transitorily stored within memory of the server. The questionnaire may be displayable at a uniform-resource-locator (URL) (i.e. a domain name) associated with the method. The questionnaire may be an interactive-web-form. An operator may access the URL via an electronic-device in communication with the WAN. The generation-script of the server-module may receive answers and selections of the questionnaire. The configuration-file may be generated by the generation-script processing the answers and the selections from the questionnaire. The configuration-file may define parameters necessary to create the COM. The configuration-file may be non-transitorily stored within the memory of the server. The server-module may generate the COM by the server-module executing the configuration-file. The created COM may comprise the configuration-file, a graphical-user-interface (GUI), a database, and at least two modules.

The GUI may display at a COM-URL (i.e. a domain name associated with the created COM). The GUI may be accessible from the electronic-device by navigating to the COM-URL. Users may interact with the COM via the GUI.

The database may non-transitorily store data of the database on the memory of the server. The data may comprise: user-accounts, including an operator-account; session-data, including user-transactions; the configuration-file, and the like.

The at least two modules may comprise a search-module and a transaction-module. Such modules may be discussed below.

The server-module may handle web requests made by users interacting with the GUI. The server-module may execute user-transactions between users. The server-module may non-transitorily store executed user-transactions within the database.

The method and/or the system may be deployed in a server-client environment, a cloud environment, or both.

It is an objective of the present invention to provide a single method for generating a variety of distinct and different COMs. For example, and without limiting the scope of the present invention, such functionally diverse and distinct COMs may be a COM directed at facilitating sales of a particular type of good, e.g. real estate; whereas another COM may be directed at facilitating sales of a particular service (i.e. one particular service per a single COM), such as personal training, dog walking, wedding planning, legal services, and the like.

It is another objective of the present invention to provide a single method for generating a variety of distinct and different COMs, wherein an Operator who desires the COM to be built may mitigate and/or avoid a need to engage in expensive and time consuming custom programming in order to generate the COM.

It is another objective of the present invention to provide a single method for generating a variety of distinct and different COMs, wherein the method may be flexible to support a variety of different business logics that may applied to a given created COM.

It is another objective of the present invention to provide a single system for generating a variety of distinct and different COMs.

It is another objective of the present invention to provide a single system for generating a variety of distinct and different COMs, wherein the system may be flexible to support a variety of different business logics that may applied to a given created COM.

It is yet another objective of the present invention to provide a single system for generating a variety of distinct and different COMs, wherein an Operator who desires the COM to be built may mitigate and/or avoid a need to engage in expensive and time consuming custom programming in order to generate the COM.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1(a) may depict an exemplary flow diagram of the steps in creating a given custom-online-marketplace (COM).

FIG. 1(b) may depict an exemplary flow diagram of how users (e.g. Operators, Sellers, Buyers, and Staff) may interact with a given created COM.

FIG. 2 may depict an exemplary block diagram of how users (e.g. Operators, Sellers, Buyers, and Staff) may interact with a given created COM.

FIG. 3 may depict a block diagram showing the main categories of a Questionnaire.

FIG. 3(a) may depict a block diagram of an Operator Supplied-Data (OSD) category of the Questionnaire.

FIG. 3(b) may depict a block diagram of a Predetermined Options (PO) category of the Questionnaire.

FIG. 3(c) may depict a block diagram of a Seller Buyer Characteristics (S&BC) category of the Questionnaire.

FIG. 3(d) may depict a block diagram of a Modules (M) category of the Questionnaire.

FIG. 4(a) may depict an Operator-Login-Webpage, wherein the Operator-Login-Webpage may be a webpage associated with the method.

FIG. 4(b) may depict an Operator-Account-Creation-Webpage, wherein the Operator-Account-Creation-Webpage may be a webpage associated with the method.

FIG. 4(c) may depict the Operator-Account-Creation-Webpage, wherein the Operator-Account-Creation-Webpage may be a webpage associated with the method and wherein the Operator-Account-Creation-Webpage may be populated with Operator-Data.

FIG. 4(d) may depict a Portal-Webpage wherein the Operator may access a Questionnaire, wherein the Portable-Webpage may be a webpage associated with the method.

FIG. 4(e) may depict a webpage of the Questionnaire wherein the Operator may provide Operator-Supplied-Data.

FIG. 4(f) may depict the webpage of FIG. 4(e) wherein the Operator may have provided Operator-Supplied-Data.

FIG. 4(g) may depict a webpage of the Questionnaire wherein the Operator may make selections of Predetermined-Options, with default selections displayed.

FIG. 4(h) may depict the webpage of FIG. 4(g) wherein the Operator may have made selections of Predetermined-Options.

FIG. 4(i) may depict a webpage of the Questionnaire wherein the Operator may make selections of features to be included within a Product-Module.

FIG. 4(j) may depict a webpage of the Questionnaire wherein the Operator may provide Operator-Supplied-Graphical-Elements and/or wherein the Operator may select some Theme selections to be applied to a look and feel of a generated COM.

FIG. 4(k) may depict a webpage of the Questionnaire wherein the Operator may have provided Operator-Supplied-Graphical-Elements and/or wherein the Operator may have selected some Theme selections to be applied to a look and feel of a generated COM.

FIG. 4(l) may depict a webpage notification message that a webpage has or may be in the process of transmitting completed Questionnaire information to a Server-Module.

FIG. 4(m) may depict a webpage notification message that the Server-Module may be constructing a Configuration-File from the transmitted completed Questionnaire.

FIG. 4(n) may depict a webpage notification message that the Server-Module may be using the generated Configuration-File to aid in configuring a Database of the COM.

FIG. 4(o) may depict an Admin-Portal-Webpage for entry into an Admin-Dashboard of the Operator for managing the generated COM.

FIG. 4(p) may depict a feature of the Admin-Dashboard of the Operator, wherein the Operator may have a means to notify prospective sellers that the generated COM may now be ready to be populated with Sellers.

FIG. 4(q) may depict the feature of the Admin-Dashboard of the Operator, wherein the Operator may have drafted a notification to a prospective Seller that the generated COM may now be ready to be populated with Sellers.

FIG. 4(r) may depict a COM-homepage of a generated COM.

FIG. 4(s) may depict a COM-webpage that a Buyer may be directed to after entering the generated COM via the COM-homepage, wherein the COM-webpage may present the Buyer with a Search-Module and brief summaries of various Seller-Profiles.

FIG. 4(t) may depict a Seller-Web-Page of a particular Seller within the generated COM.

FIG. 5 may depict the main hardware components of a server, as a block diagram, wherein the server facilitates creating the COM and maintaining the created COM.

### DETAILED DESCRIPTION OF THE INVENTION

A method and system for generating a variety of distinct and functionally different custom-online-marketplaces (COMs) is described. For example, and without limiting the scope of the present invention, such functionally diverse and distinct COMs may be a COM directed at facilitating sales of a particular type of good, e.g. real estate; whereas another COM may be directed at facilitating sales of a particular service (i.e. one particular service per a single COM), such as personal training, dog walking, wedding planning, legal services, and the like.

Such a system may comprise: a server, a server-module, a questionnaire, a generation-script, and a configuration-file. The server may be in communication with a wide-area-network (WAN), such as the internet. The server-module may be running on the server. The server-module may be non-transitorily stored within memory of the server. The questionnaire may be displayable at a uniform-resource-locator (URL) (i.e. a domain name) associated with the method. The questionnaire may be an interactive-web-form. An operator may access the URL via an electronic-device in communication with the WAN. The generation-script of the server-module may receive answers and selections of the questionnaire. The configuration-file may be generated by the generation-script processing the answers and the selections from the questionnaire. The configuration-file may define parameters necessary to create the COM. The configuration-file may be non-transitorily stored within the memory of the server. The server-module may generate the COM by the server-module executing the configuration-file. The created COM may comprise the configuration-file, a graphical-user-interface (GUI), a database, and at least two modules.

The GUI may display at a COM-URL (i.e. a domain name associated with the created COM). The GUI may be accessible from the electronic-device by navigating to the COM-URL. Users may interact with the COM via the GUI.

The database may non-transitorily store data of the database on the memory of the server. The data may comprise: user-accounts, including an operator-account; session-data, including user-transactions; the configuration-file, and the like.

The at least two modules may comprise a search-module and a transaction-module. Such modules may be discussed below.

The server-module may handle web requests made by users interacting with the GUI. The server-module may execute user-transactions between users. The server-module may non-transitorily store executed user-transactions within the database.

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

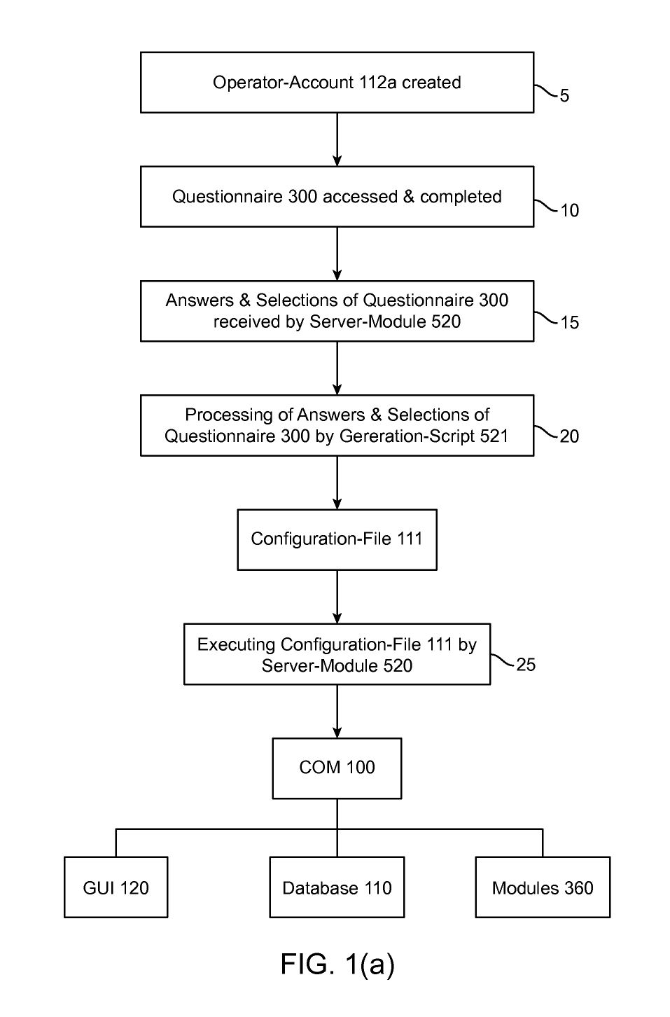

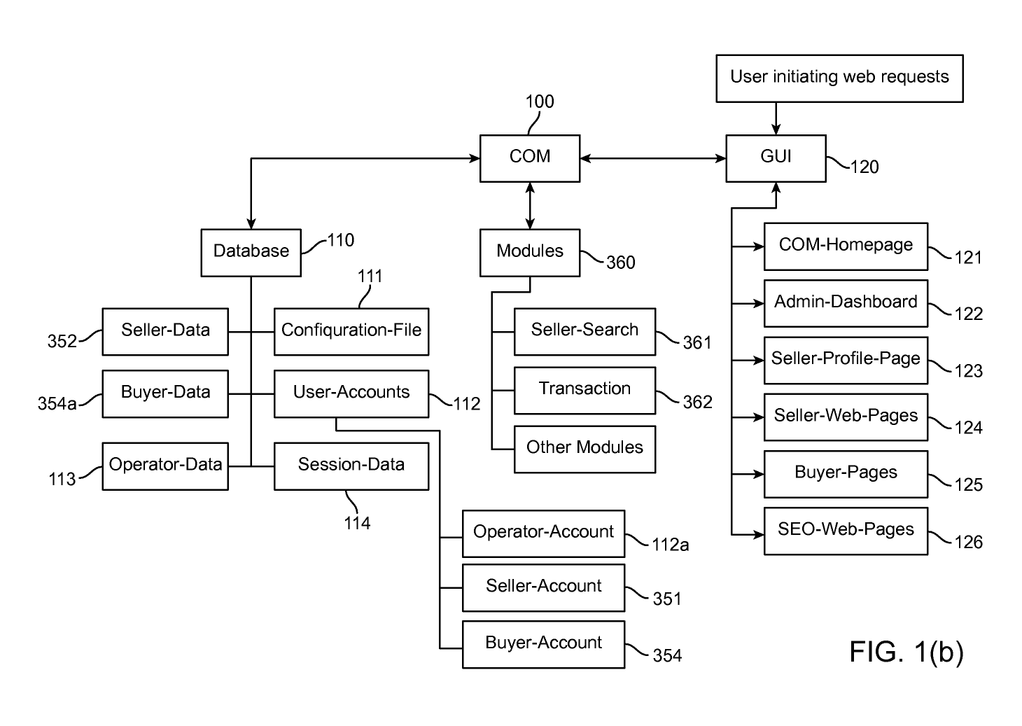

FIG. 1(a) may depict an exemplary flow diagram of the main steps in generating a given custom-online-marketplace (COM) 100. In some exemplary embodiments, the method may comprise the steps of: Step 5, Step 10, Step 15, Step 20, and Step 25.

Step 5: Receiving Operator-Data 113 necessary to create an Operator-Account 112a. In some embodiments the Operator having created Operator-Account 112a may be a prerequisite for accessing a Questionnaire 300. Operator-Data 113, for the purpose of creating Operator-Account 112a, may comprise: an operator-email-address, an operator-name (e.g. a username), and an operator-password. Operator-Data 113 may be data that may be non-transitorily stored within Database 110, e.g. within Memory 502.

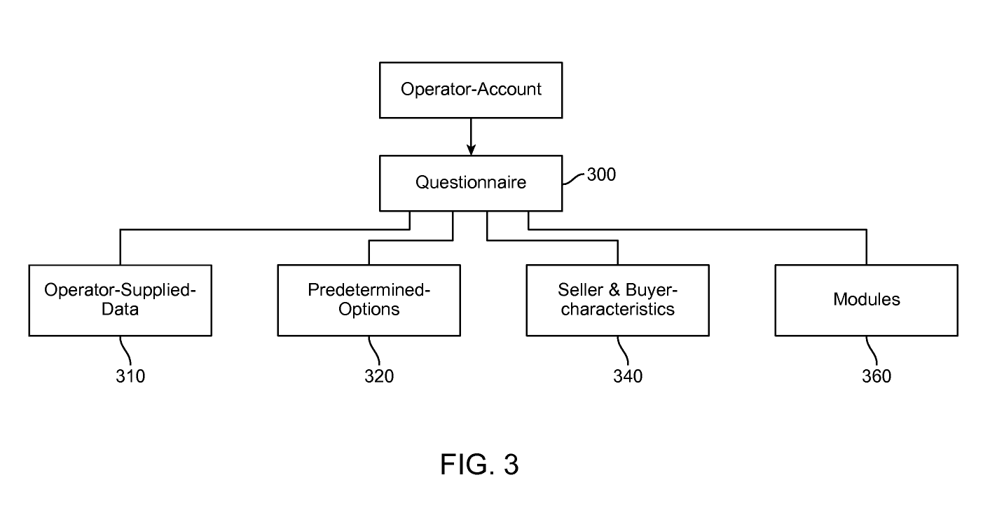

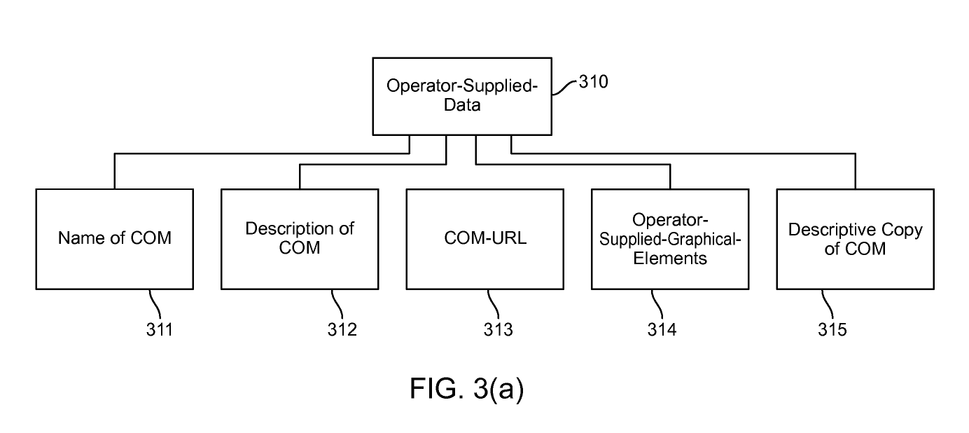

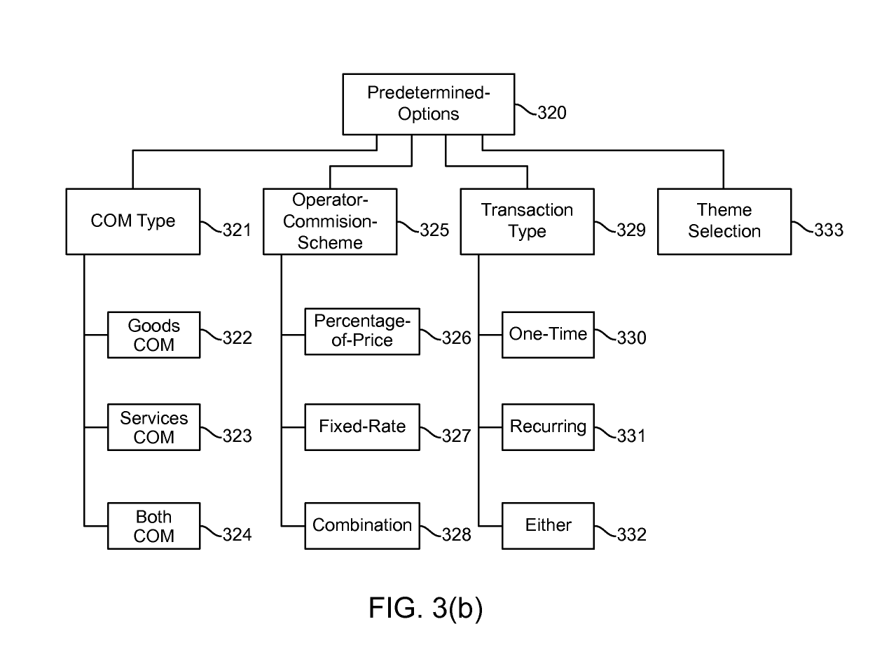

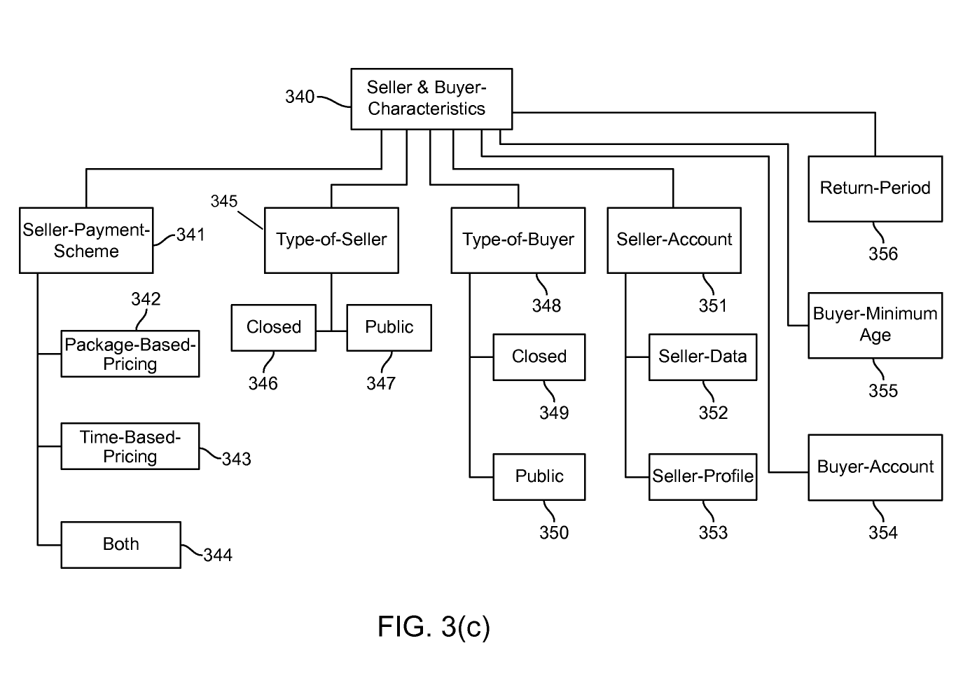

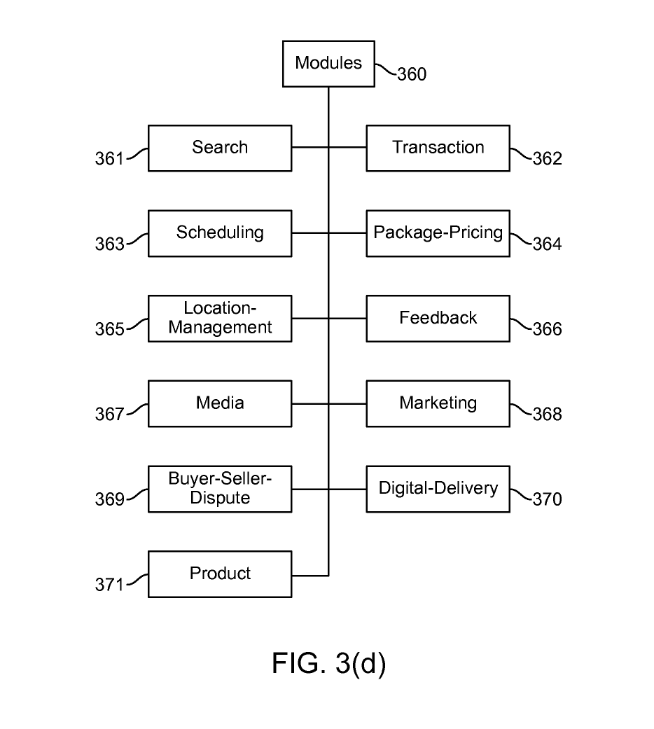

Step 10: The Operator may access and complete Questionnaire 300. The various components of Questionnaire 300 may be depicted in the FIG. 3 series of figures. Questionnaire 300 may be an interactive web-form that may be displayed on a website at a uniform-recourse-locator (URL) (i.e. domain name) associated with the method. The URL associated with the method may a different URL than associated with any given COM 100, which may be designated as COM-URL 313, i.e. a domain name specific to a created COM 100.

Step 15: A server-module 520 may receive Answers and Selections of Questionnaire 300. Server-module 520 may be executable code running on a Server 500 and may be discussed further in the system discussion below.

Step 20: A Generation-Script 521 may process the Answers and the Selections of Questionnaire 300. Generation-Script 521 may be executable code capable of being run on Server 500 and may be discussed further in the system discussion below.

A product of Generation-Script's 521 processing the Answers and the Selections of Questionnaire 300 may be a Configuration-File 111. Configuration-File 111 may define parameters necessary to create COM 100. Such parameters may be determined by completing Questionnaire 300.

Step 25: The Server-Module 520 may execute the Configuration-File 111 to generate COM 100.

In some embodiments, COM 100 may comprise: Configuration-File 111, a Database 110, a Graphical User-Interface (GUI) 120, and at least two Modules 360. Configuration-File 111 was noted above. GUI 120 and Database 110 are both discussed next below. The at least two Modules 360 may be discussed in the FIG. 3(d) discussion further below.

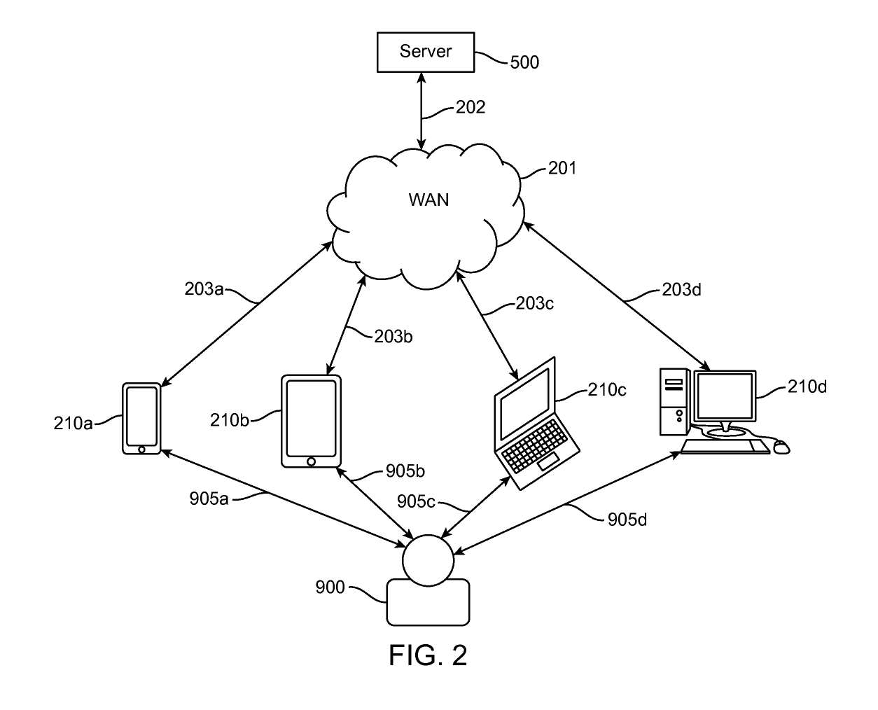

In some embodiments, GUI 120 may display at COM-URL 313 received by Server-Module 520 from the Operator. GUI 120 may be accessible by a User 900 (see FIG. 2 for User 900) navigating to COM-URL 313. Users 900 may interact with COM 100 via GUI 120.

In some embodiments, Database 110 may non-transitorily store and organize various data, including the data which may comprise: User-Accounts 112, including Operator-Account 112a; Session-Data 114, including User-Transactions; and Configuration-File 111. For example, and without limiting the scope of the present invention, Session-Data 114 may comprise User-Transactions, wherein an example of a User-Transaction may be a buy-sale transaction between a Buyer and a Seller utilizing generated COM 100.

In some embodiments, Database 110 may be database-agnostic. In some embodiments, Database 110 may be configured using MongoDB®. In some embodiments, Database 110 may be configured using relational or NoSQL databases such as MySQL®, Postgres®, CouchDB®, and the like.

In some embodiments, the Operator may be responsible for registering COM-URL 313 and for providing this COM-URL 313 to the method and/or system, e.g. when prompted for this information by Questionnaire 300 (e.g. as a component requested of Operator-Supplied-Data 310). The Operator may receive DNS name-server information of Server-Module 520 and Server 500 from the method and/or system and the Operator may then edit DNS settings of COM-URL 313 so that the COM-URL 313 may be associated with the build COM 100.

In some embodiments, all created COM's 100 may be associated with a single internet protocol (IP) address associated with Server-Module 520 and Server 500. Server-Module 520 may always be running on Server 500. Server-Module 520 may be listening for web requests, responding to web requests, and performing time-based tasks that may be independent of web requests, also known as CRON jobs. For example, and without liming the scope of the present invention, Server-Module 520 may be listening for web requests of COM-URL 313 and may respond to such requests by displaying a given GUI 120 associated with the requested COM 100.

In some embodiments, each created COM 100 may be associated with a specific IP address served by Server-Module 520 and Server 500. In such embodiments, either during completion of Questionnaire 300 or after completion of Questionnaire 300, Server-Module 520 may provide a first-notification to the Operator of the IP address to be associated with COM 100. The first-notification may be by a webpage viewable by the Operator, by an email sent to the Operator, and/or by a text message sent to the Operator. In such embodiments, the method may comprise a step of providing the Operator with a second-notification that the Operator should forward COM-URL 313 to point at the IP address associated with COM 100. COM-URL 313 may be a domain name supplied by the Operator.

FIG. 1(b) may depict an exemplary flow diagram of how Users 900 (e.g. Operators, Sellers, Buyers, and Staff) may interact with a given created COM 100. Once the given COM 100 may be generated, as depicted by the steps of FIG. 1(a), Users 900 may interact with the given generated COM 100. In some embodiments, Server-Module 520 may handle web requests made by Users 900 interacting with GUI 120. Server-Module 520 may execute User-Transactions between Users 900. Server-Module 520 may direct executed User-Transactions to be non-transitorily stored within Database 110.

Users 900 may comprise Operators, Sellers, Buyers, Staff, and the like.

The Operators may be entities who initiate generation (creation, formation) of COM 100 via the method as depicted in FIG. 1(a). The Operators may be responsible for marketing COM 100, for finding Sellers for COM 100, and for finding Buyers for COM 100. The Operators may manage COM 100 once created by the method.

The Sellers may be entities offering goods and/or services on COM 100 for the Buyers to purchase. The Buyers may be entities that purchase or browse for goods and/or servicers offered by the Sellers on COM 100.

The Staff may be entities associated with execution and maintenance of the method and the system. Staff may be agents, employees, and/or independent contractors of an entity responsible for executing and maintaining the method and/or system. For example, and without limiting the scope of the present invention, the Staff may be agents, employees, and/or independent contractors of owners, assignees and/or licensees of the present invention.

Note “entities” as used above may refer to both individuals and/or various business forms, such as corporations, limited liability companies, partnerships, associations, and the like.

Turning back to FIG. 1(b), Users 900 may interact with the generated COM 100 by first navigating to COM-URL 313 (i.e. COM-domain-name). In some embodiments, Server-Module 520 may recognize various web requests for COM-URL 313. As explained further in the FIG. 3 series of figures discussion, as part of the information received by Server-Module 520 from the Operator when the Operator completes Questionnaire 300, the Operator may provide COM-URL 313 to the method and/or system. Continuing, with FIG. 1(b), Server-Module 520 may then load the requested COM 100 (by reading/executing the appropriate Configuration-File 111), and cause GUI 120 to display an appropriate webpage of the already created COM 100, such as COM-Homepage 121.

FIG. 1(b) may also depict further subcomponents of COM 100, such as subcomponents of Database 110, subcomponents of Module 360, and subcomponents of GUI 120.

As noted above in the FIG. 1(a) discussion, in some embodiments, Database 110 may non-transitorily store: User-Accounts 112, including Operator-Account 112a; Session-Data 114, including User-Transactions; and Configuration-File 111. Database 110 may be further discussed below in the system discussion.

In some embodiments, COM 100 may comprise at least mandatory Modules 360, a Search-Module 361 and a Transaction-Module 362. These modules as well as other Modules 360 may be discussed in the FIG. 3(d) discussion further below.

In some embodiments, GUI 120 may comprise: COM-Homepage 121, a Seller-Profile-Page 123, an Admin-Dashboard 122, a Seller-Web-Page 124, Buyer-Pages 125, SEO-Web-Pages 126, and the like.

In some embodiments, COM-Homepage 121 may be a webpage. COM-Homepage 121 may be a primary entry point into GUI 120 of COM 100 for Users 900 (see FIG. 2 for Users 900). In some embodiments, COM-Homepage 121 may be accessible by Users 900 navigating to COM-URL 313 associated with the built COM 100. In some embodiments, COM-Homepage 121 may be accessible by Users 900 navigating to an IP address associated with the built COM 100. COM-Homepage 121 may comprise functionality of at least one user log-in link and/or at least one new user account creation link, so Users 900 (e.g. Sellers and Buyers) may create User-Accounts 112 to gain access to the other webpages of GUI 120.

In some embodiments, Seller-Profile-Page 123 may display Seller-Data 352 associated with Seller-Profile 353. A given Seller-Profile-Page 123 may be a webpage component of GUI 120, wherein the various Seller-Data 352 constituting a given Seller-Profile 353 may be displayed. See FIG. 3(c) and the FIG. 3(c) discussion for further details on Seller-Data 352 and Seller-Profile 353.

Continuing with discussing FIG. 1(b), in some embodiments, Admin-Dashboard 122 may be accessible by the Operator logging into Operator-Account 112a. Such a log in location may be found on COM-Homepage 121 and/or on webpages associated with the method/and or system. Admin-Dashboard 122 may be a plurality of webpage components of GUI 120. Within Admin-Dashboard 122 the Operator may have options to select and view various statistics associated with performance of COM 100. For example, and without limiting the scope of the present invention, Admin-Dashboard 122 may provide such statistics as: total number of Sellers, total number of Buyers, COM 100 revenue per Seller, total revenue for COM 100 across all Sellers, Operator revenue, number of visitors to GUI 120, and the like. Various time periods may also be applied as filters to such statistics and to generate various custom reports of such statistics.

In some embodiments, within Admin-Dashboard 122 the Operator may have the option to select and view User-Transactions, such as completed transactions and pending transactions. Admin-Dashboard 122 may display the Operator's answers and selections to Questionnaire 300. Within Admin-Dashboard 122 the Operator may be able to edit the answers and the selections to Questionnaire 300, such that an updated-configuration-file may be created, wherein Server-Module 520 may execute the updated-configuration-file to generate an updated-COM 100.

In some embodiments, GUI 120 may comprise Seller-Web-Page 124. Seller-Web-Page 124 may display information describing the Seller's goods and/or services for sale within COM 100. In some embodiments, Seller-Web-Page 124 may comprise a plurality of Seller-Web-Page 124 for a given Seller, wherein each Seller-Web-Page 124 may describe a single good and/or service. In some embodiments, Seller-Profile-Page 123 may comprise Seller-Web-Page 124. In some embodiments, Seller-Profile-Page 123 may comprise hyperlinks to Seller-Web-Page 124.

In some embodiments, GUI 120 may comprise Buyer-Pages 125. Buyer-Pages 125 may be accessible by Buyers logging into (or creating) Buyer-Account 354 from COM-Homepage 121. Buyer-Pages 125 may comprise various webpages specific to Buyer needs. Buyer-Pages 125 may include an ability to interact with Search-Module 361 (e.g. a Seller-Search-Module) so that Buyers may perform various searches for goods (products), services, particular Sellers, and the like. Buyer-Pages 125 may also include an ability to display Buyer-Histories, wherein Buyer-Histories may be generated from various Session-Data 114 and/or Buyer-Data 354a.

In some embodiments, GUI 120 may comprise SEO-Web-Pages 126. SEO-Web-Pages 126 may be specific webpages that Server-Module 520 builds and displays based upon various web requests. Such webpages may then be directed to Buyer, Seller, or Operator needs depending upon if the initial web request was from a Buyer, a Seller, or an Operator. For example, and without limiting the scope of the present invention, consider a prospective Buyer running a Google search for “personal trainers upper west side,” Server-Module 520 may recognize this web request and build and display a webpage with personal trainers that may train in the Upper West Side, assuming that a personal training COM 100 had already been created by an Operator that covers that geographical region.

In some embodiments, a uniform look and feel applied to GUI 120. In some embodiments, the uniform look and feel may be supplied by Operator-Supplied-Graphical-Elements 314, selected Them 333, or a default look and feel if no Operator-Supplied-Graphical-Elements 314 are supplied and no Theme 333 is selected. See FIG. 3(a) and FIG. 3(a) discussion for further details regarding Operator-Supplied-Graphical-Elements 314. See FIG. 3(b) and FIG. 3(b) discussion for further details regarding Theme 333.

FIG. 2 may depict an exemplary block diagram of how Users 900 (e.g. Operators, Sellers, Buyers, and Staff) may interact with a given created COM 100.

Note, FIG. 2 may differ from FIG. 1(b), in that FIG. 2 may focus on depicting the various hardware components that may be used to interact with the method, such as Server 500, various Electronic-Devices 210, and WAN 201 (wide area network, which may include the internet).

Users 900 may interact with the method and/or system by interacting with Server 500, through various intermediaries. The various intermediaries may comprise WAN 201 and various Electronic-Devices 210. WAN 201 may be in communication with Server 500 via Communication-Route 202, which may be wireless, wired, or a combination of wireless and wired connections. Electronic-devices 210 may comprise Smartphone 210a, Tablet-Device 210b, Laptop 210c, Desktop 210d, and the like. Electronic-devices 210 may be various computing devices which may be configured to communicate with WAN 201, via wireless, wired, or a combination of electronic communication protocols. User 900 may interact with the various Electronic-Devices 210 by Interactions 905 (e.g. 905a).

Users 900 may interact with the method and/or the system via a web-browser running on one of the Electronic-Devices 210 that User 900 may be interacting with. Users 900 may interact with the method and/or the system via a down-loaded “mobile app” running on one of the Electronic-Devices 210 that User 900 may be interacting with. Thus, the method and/or the system may be deployed in a traditional client-server architecture or in a cloud architecture.

Initially before a given COM 100 may be created, the Operator may navigate to an entry webpage of the method and/or the system by entering a URL (domain name) associated with the method and/or system, wherein the entry webpage may be a webpage being served by Server 500, via Server-Module 520 operating on Server 500. The Operator may then have to create an Operator-Account 112a, wherein once created, the Operator may then access Questionnaire 300.

FIG. 3 may depict a block diagram showing the main categories of Questionnaire 300. In some exemplary embodiments, creation of Operator-Account 112a may be required before the Operator may be able to access Questionnaire 300. The method may further comprise the step of Server-Module 520 receiving Operator-Data 113 to create Operator-Account 112a. (See e.g., FIG. 1(a) and FIG. 1(b).) Operator-Data 113 may comprise: the operator-email-address, the operator-name (e.g. a username), and the operator-password. Operator-Data 113 may be data that may be non-transitorily stored within Database 110, e.g. within Memory 502.

In some embodiments, the main categories of Questionnaire 300 may comprise Operator-Supplied-Data 310, Predetermined-Options 320, Seller-and-Buyer-Characteristics 340, and Modules 360.

In some embodiments, the Operator, in answering and making selections from Questionnaire 300, may provide Operator-Supplied-Data 310, may select from Predetermined-Options 320, may select Seller-and-Buyer-Characteristics 340, and may select from at least two mandatory Modules 360 to incorporate into COM 100. Each of these four main categories of Questionnaire 300 may be discussed further below.

FIG. 3(a) may depict a block diagram of Operator-Supplied-Data 310 main category of Questionnaire 300. In some embodiments, Operator-Supplied-Data 310 may comprise three mandatory elements: a Name-of-COM 311, a Description-of-COM 312, and COM-URL 313. All three elements may be entered into text fields within Questionnaire 300 by the Operator.

In some embodiments, Name-of-COM 311 may be a title of COM 100 to be created, e.g. of how the Operator envisions the created COM 100 to generally be known by COM's 100 intended users. Name-of-COM 311 may be words and/or phrasing that may become a brand of COM 100 and may be something that the Operator may seek to trademark. Name-of-COM 311 may include words that may be descriptive of COM 100 to be created. For example, in a personal training COM 100, Name-of-COM 311 might be, “The Personal Training Exchange of Atlanta.” In some embodiments, the text field for receiving Name-of-COM 311 may be limited to a specific maximum number of characters or words. For example, and without limiting the scope of the present invention, the text field for receiving Name-of-COM 311 may be limited to a maximum number of 125 characters. In other embodiments, a different maximum may be set. Note, this may be a limit imposed upon the Operator by the method and/or the system.

In some embodiments, Description-of-COM 312 may be a short description of COM 100 to be created, wherein the method and/or the system may impose a maximum number of words that the Operator may use to briefly describe COM 100 to be created. For example, and without limiting the scope of the present invention, the text field for receiving Description-of-COM 312 may be limited to a maximum number of 150 words. In other embodiments, a different maximum may be set. Description-of-COM 312 may provide an opportunity to the Operator to expand upon and/or to compliment Name-of-COM 311. Description-of-COM 312 should briefly describe who COM 100 may be benefiting and/or COM's 100 purpose.

In some embodiments, COM-URL 313 may be a domain name registered and/or controlled by the Operator. COM-URL 313 may be the domain name that the Operator wishes COM 100 to be created to be publicly known by. Where possible, it may be desirable for Name-of-COM 311 and for COM-URL 313 to be as similar in spelling to each other as possible, as this may benefit search engine ranking of the built COM 100. Functionally, Server-Module 520 receiving COM-URL 313 as an answer to Questionnaire 300 may be important as Server-Module 520 may need to know COM-URL 313 in order to build, load, and display the proper COM 100 when User 900 may enter COM-URL 313 into a web-browser.

In some embodiments, Operator-Supplied-Data 310 may comprise optional elements of: Operator-Supplied-Graphical-Elements 314 and/or Descriptive-Copy-for-COM 315.

For example, and without limiting the scope of the present invention, Operator-Supplied-Graphical-Elements 314 may comprise a CSS (custom-style-sheet) file or some JavaScript®, that the Operator may upload to Server 500 when prompted by Operator-Supplied-Data 310 of Questionnaire 300. Operator-Supplied-Graphical-Elements 314 may comprise the necessary graphical, style, and formatting information such that Server-Module 520 may construct and display the look and feel of GUI 120 of COM 100. Operator-Supplied-Graphical Elements 314 may include a logo, color schemes, layout schemes, and the like.

In some embodiments, upon uploading Operator-Supplied-Graphical-Elements 314 to Server 500, the Operator may be given an opportunity to preview how Operator-Supplied-Graphical-Elements 314 may be applied to GUI 120, wherein such a preview step may allow the Operator to validate if the upload of Operator-Supplied-Graphical-Elements 314 was successful and/or if the Operator likes the resulting look and feel of GUI 120.

In some embodiments, Operator-Supplied-Graphical-Elements 314 may be optional for the Operator to supply to Server 500. In such embodiments, if the Operator does not provide any Operator-Supplied-Graphical-Elements 314, then the Operator may alternatively select from one of several presented Themes 333 to govern the look and feel of GUI 120; or in some other embodiments, if the Operator does not supply Operator-Supplied-Graphical-Elements 314 and also does not select a Theme 333, then the method and/or the system may supply a default setting to govern the look and feel of GUI 120. Theme 333 may be discussed below at the end of the discussion of FIG. 3(b).

Continuing with discussing FIG. 3(a), in some embodiments, Descriptive-Copy-for-COM 315 may be a longer description of COM 100 to be created, wherein the method and/or the system may impose a maximum number of words that the Operator may use to more fully describe the COM 100 to be created. Descriptive-Copy-for-COM 315 may provide an opportunity to the Operator to expand upon and/or to compliment Description-of-COM 312. The text field for receiving Descriptive-Copy-for-COM 315 may accommodate more words than the text field for receiving Description-of-COM 312. In some embodiments, Descriptive-Copy-of-COM 315 may include HTML markup language. In some embodiments, Description-of-COM 312 and Descriptive-Copy-for-COM 315 may display at different locations within webpages of GUI 120.

FIG. 3(b) may depict a block diagram of Predetermined-Options 320 main category of Questionnaire 300. Predetermined-Options 320 may present lists of predetermined options in several subcategories that the Operator may select from to assist in defining certain features of COM 100 to be created. Predetermined-Options 320 may be further subdivided into the following subcategories: a COM-Type 321, an Operator-Commission-Scheme 325, a Transaction-Type 329, Theme 333, and the like.

In some embodiments, Predetermined-Options 320 may comprise selecting Type-of-COM 321. Type-of-COM 321 may be selected from the group comprising: a Goods-COM 322, a Services-COM 323, or both a Goods-and-Services-COM 324.

In Goods-COM 322, the Seller may be selling goods, i.e. products. Such goods may be physical and/or virtual. For example, and without limiting the scope of the present invention, a virtual good may be a digital file generally containing some work of authorship that may have been authored prior to the Buyer ordering the virtual good, e.g. an e-book. In Goods-COM 322, the Seller may be able to create multiple pages, i.e. Seller-Web-Pages 124 for display and access on GUI 120. Each such page may represent one particular type of good for sale (e.g. the Seller selling off their art collection, each artwork may have their own good page).

In Services-COM 323, the Seller may be providing various services. Services may be location dependent and/or location independent. Location dependent services may mean the Seller may be physically going to perform a service to the Buyer at some location. This may be either a task that takes place at the Buyer's location (e.g. mowing of a lawn) or at a 3rd party location (e.g. personal trainer workout at a park). Location independent services may be performing a remote task (e.g. a lawyer preparing a document for you and delivering the work-product). For example, and without limiting the scope of the present invention, a location independent service may be the Seller providing a digital file containing a report ordered by the Buyer from the Seller. In Services-COM 323, one Seller may have one Seller-Profile-Page 123 displayed and accessible on GUI 120 where the Seller may showcase services being offered.

In Goods-and-Services-COM 324, the Seller may be offering both goods and services. In Goods-and-Services-COM 324, the Seller may have one seller-web-page with multiple physical goods available on it. Such as a hard-wood installer might have ten different types of floors they showcase on their Seller-Profile-Page 123 or on their Seller-Web-Pages 124. The Buyer may then buy the floor materials (i.e. the goods) and the Buyer may also buy installation (i.e. the service) of the flooring.

In some embodiments, Predetermined-Options 320 may comprise selecting Operator-Commission-Scheme 325. Operator-Commission-Scheme 325 may define how the Operator may be compensated financially for transactions occurring on COM 100 to be created. Operator-Commission-Scheme 325 may be selected from the group comprising: a Percentage-of-Price 326, a Fixed-Rate 327, or a Combination-of-Percentage-of-Price-and-Fixed-Rate 328.

If Percentage-of-Price 326 may be selected, then the Operator may specify a percentage of each transaction that occurs on COM 100 to be collected and set aside for compensation for the Operator. In some embodiments, the method and/or the system may include minimum and/or maximum percentages that the Operator may select from.

If Fixed-Rate 327 may be selected, then the Operator may specify a fixed rate (i.e. flat rate) of each transaction that occurs on COM 100 to be collected and set aside for compensation for the Operator. In some embodiments, the method and/or the system may include minimum and/or maximum fixed rates that the Operator may select from.

If Combination-of-Percentage-of-Price-and-Fixed-Rate 328 may be selected, then the Operator may specify a percentage of each transaction that occurs on COM 100 to be collected and set aside for compensation for the Operator; and the Operator may specify a fixed rate (i.e. flat rate) of each transaction that occurs on COM 100 to be collected and set aside for compensation for the Operator. Alternatively, in some embodiments, if Combination-of-Percentage-of-Price-and-Fixed-Rate 328 may be selected, then some transactions occurring on COM 100 may be percentage based compensation, while other transactions occurring on COM 100 may be fixed-rate. For example, and without limiting the scope of the present invention, the first transaction between a given Buyer and given Seller may be fixed rate compensation for the Operator, while subsequent transactions between that Buyer and that Seller may be percentage of price compensation for the Operator.

In some embodiments, Predetermined-Options 320 may comprise selecting Transaction-Type 329 that may be applicable to COM 100. Transaction-Type 329 may be selected from the group comprising: a One-Time-Transaction 330, Recurring-Transactions 331, or Either-One-Time-Transaction-or-Recurring-Transactions 332.

For example, and without limiting the scope of the present invention, a COM 100 that may utilize the One-Time-Transaction 330 may be a COM 100 that connects wedding planners (Sellers) with prospective brides (Buyers). For example, and without limiting the scope of the present invention, COM 100 that may utilize Recurring-Transactions 331 may be a COM 100 that connects dog walkers (Sellers) with dog owners (Buyers), wherein the dog walker may take a dog for a walk five days out of a seven day week. For example, and without limiting the scope of the present invention, COM 100 that may utilize either and/or both transaction-type models (e.g. Either-One-Time-Transaction-or-Recurring-Transactions 332) may be a COM 100 that connects lawyers (Sellers) with clients (Buyers), as many legal services are one-time transactions, but other legal services may involve ongoing legal services.

In some embodiments, Predetermined-Options 320 may comprise selecting Theme 333 from a finite list of themes presented to the Operator in Questionnaire 300. The selected Theme 333 may be applied to GUI 120. The selected Theme 333 may govern the look and feel of GUI 120. The look and feel may be the color schemes and layout schemes that may be applied to the visual elements of GUI 120.

In some embodiments, if the Operator had previously supplied Operator-Supplied-Graphical-Elements 314 when completing the Operator-Supplied-Data 310 category of Questionnaire 300, then the Operator may not be given the opportunity to select a Theme 333.

FIG. 3(c) may depict a block diagram of Seller-&-Buyer-Characteristics 340 main category of Questionnaire 300. Seller-&-Buyer-Characteristics 340 may be further subdivided into the following subcategories: a Seller-Payment-Scheme 341, a Type-of-Seller 345, a Type-of-Buyer 348, a Seller-Account 351, a Buyer-Account 354, a Buyer-Mini m-Age 355, a Return-Period 356, and the like. Each of these subcategories may be discussed below.

In some embodiments, Seller-&-Buyer-Characteristics 340 may comprise selecting a Seller-Payment-Scheme 341 that may be applicable to COM 100. Seller-Payment-Scheme 341 may define how the Seller may be financially compensated for various transactions with Buyers in COM 100. Seller-Payment-Scheme 341 may be selected from the group comprising: Package-Based-Pricing 342, Time-Based-Pricing 343, or a Combination-of-Package-based-Pricing-and-Time-Based-Pricing 344.

In some embodiments, Package-Based-Pricing 342 may mean the Seller provides one-batch of services or goods for a fixed price. For example, this may be ten sessions of personal training provided by the Seller to the Buyer at one fixed price. Or this may be one session of personal training at one fixed price.

Time-Based-Pricing 343 may be more applicable to services COM's 100, i.e. where service may take an amount of time to accomplish. For example, the Buyer and Seller may agree on amount of time needed to mow a certain lawn based on the size of the lawn. This service, lawn mowing, may then require the Buyer to purchase three hours of lawn mowing services.

Combination-of-Package-based-Pricing-and-Time-Based-Pricing 344 may mean the Seller may decide on how they want to sell their services. For example, a lawyer might want to sell certain services under Package-Based-Pricing 342 (e.g. preparing non-disclosure agreements (NDAs) for $100) or the lawyer may want to charge the client (Buyer) by the hour for legal services under Time-Based-Pricing 343.

In some embodiments, the Operator may set a unit for Package-Based-Pricing 342. In some embodiments, the Operator may permit the Seller to determine the units for Package-Based-Pricing 342. For example in COM 100 that matches personal trainers (Sellers) to clients (Buyers), the only “unit” sold may be “one hour training sessions,” so then the Operator may mandate “one hour training sessions,” as the unit for Package-Based-Pricing 342.

However in other types of COM's 100, where the units for Package-Based-Pricing 342 may vary, then the Operator may permit the Seller to determine the units for Package-Based-Pricing 342. For example, in a COM 100 connecting lawyers (Sellers) to clients (Buyers), the Operator might leave the choice of specifying the units for the package-based-pricing up to the lawyer, as the lawyer may be providing a range of services (e.g. preparing NDAs and preparing paperwork for incorporation).

In some embodiments, the Operator may permit the Seller to determine a price for the units for Package-Based-Pricing 342. In some embodiments, the Operator may determine the price for the units for Package-Based-Pricing 342. In some embodiments, the Operator may select a minimum-price for the units for Package-Based-Pricing 342. In some embodiments, the Operator may select a maximum-price for the units for Package-Based-Pricing 342. Such minimum and maximum prices may be restrictions on the price that the Seller may set.

In some embodiments, Time-Based-Pricing 343 may comprise a price per a unit-of-time. In some embodiments, the Operator when answering and/or making selections of Seller-and-Buyer-Characteristics 340 of Questionnaire 300 may select the unit-of-time. In other embodiments, the Operator may permit the Seller to determine the applicable unit-of-time. The unit-of-time may be selected from the group comprising: seconds, minutes, hours, days, weeks, bi-monthly, months, bi-annually, annually, and the like. For example, in a legal services COM 100, a price per hour may be appropriate; whereas in a wedding planning COM 100, a price per day may be appropriate.

In some embodiments, the Operator permits the Seller to determine the price per the unit of time for Time-Based-Pricing 343. In other embodiments, the Operator may determine the price per the unit of time for Time-Based-Pricing 343.

In some embodiments, the Operator may select a price-step-rule to be applied to Seller-Payment-Scheme 341. The price-step-rule may be applied in Package-Based-Pricing 342, Time-Based-Pricing 343, or Combination-of-Package-based-Pricing-and-Time-Based-Pricing 344. The price-step-rule may force the Seller to determine prices for Package-Based-Pricing 342 in specified increments of a currency. The price-step-rule may force the Seller to determine prices for Time-Based-Pricing 343 in specified increments of the currency. For example, in some applications of the method and/or the system, the Operator may elect the price-step-rule with the specified increment of 10 U.S. dollars, and then any prices set by the Sellers must be in increments of 10 U.S. dollars.

Continuing with discussing FIG. 3(c), in some embodiments, Seller-and-Buyer-Characteristics 340 may comprise selecting Type-of-Seller 345. Type-of-Seller 345 may be either open to the public 347 or closed to the public 346. In some embodiments, Seller-and-Buyer-Characteristics 340 may comprise selecting Type-of-Buyer 348. Type-of-Buyer 348 may be either open to the public 350 or closed to the public 349.

For example, and without limiting the scope of the present invention, in COM's 100 where Type-of-Seller 345 may be closed to the public 346, becoming a Seller may be by invitation from the Operator, followed by Operator approval. In other COM's 100, where Type-of-Seller 345 may be closed to the public 346, becoming a Seller may be by invitation from the Buyer, followed by Buyer approval.

For example, and without limiting the scope of the present invention, in COM's 100 where Type-of-Buyer 348 may be closed to the public 349, becoming a Buyer may be by invitation from the Operator, followed by Operator approval. In other COM's 100, where Type-of-Buyer 348 may be closed to the public 349, becoming a Buyer may be by invitation from the Seller, followed by Seller approval.

In embodiments, wherein the Operator selects open to the public (347 and/or 350), becoming a Seller and/or a Buyer may not require invitation and subsequent approval.

Continuing with discussing FIG. 3(c), in some embodiments, Seller-and-Buyer-Characteristics 340 may comprise the Operator selecting a requirement that Sellers must create a Seller-Account 351 in order for Sellers to create Seller-Profile 353 on COM 100. When the Operator may select the requirement that the Seller creates Seller-Account 351, the Seller must provide Seller-Data 352 to COM 100 to create Seller-Account 351. Seller-data 352 may comprise: at least one seller-email-address, at least one seller-name (e.g. a username), at least one seller-password, and the like.

In some embodiments, Seller-Data 352 may further comprise: at least one unique-identifier, seller-banking-information, and at least one seller-address. For example, the at least one unique-identifier may be a social security number (SSN) of the Seller, a company identifier (such as a federal employer identification number), and the like. Seller-banking-information may comprise banking information of the Seller such as: at least one bank name, at least one bank address, at least one bank phone number, at least one bank account number (e.g. a checking account), and the bank's routing number (e.g. an ABA routing number). Such Seller-Data 352 may be used for Seller-Account 351 creation and/or Seller-Profile 353 creation, depending upon choices made by the Operator in completing Seller-and-Buyer-Characteristics 340 of Questionnaire 300.

In some embodiments, Seller-and-Buyer-Characteristics 340 may comprise the Operator selecting Seller-Data 352 that COM 100 may require from the Seller in order for the Seller to create Seller-Profile 353 for use on COM 100. In addition to Seller-Data 352 used for Seller-Account 351 creation, such Seller-Data 352 may comprise: at least one seller-headline (e.g. a marketing tagline or a unique selling proposition), at least one seller-description, at least one seller-profile-image, the at least one seller-email-address, and at least one seller-phone-number. This Seller-Data 352 may be directed at capturing general and marketing information of the Seller, rather than specific details as to the Seller's goods and/or services. For example, and without limiting the scope of the present invention, the at least one seller-profile-image may be headshot of an individual Seller or a company logo graphic for an entity Seller. Seller-Data 352 which may constitute Seller-Profile 353 may be displayed as Seller-Profile-Page 123, which as noted above may be a webpage component of GUI 120.

In some types of COM's 100, Seller-Profile 353 (displayable as Seller-Profile-Page 123) may act as the Seller's online store within COM 100 and may be where the Seller showcases their goods and/or services. Seller-Profile-Page 123 in a given COM 100 may hyperlink out to a plurality of Seller-Web-Pages 124 (of GUI 120). Each Seller-Web-Page 124 may showcase a particular good and/or service.

In some embodiments, the seller-email-address used for creating Seller-Account 351 may be a different email address than the seller-email-address used to create Seller-Profile 353. The seller-email-address used for creating Seller-Account 351 may be an email address used for logging into COM 100 and as such may be an email address that the Seller would prefer to be kept private. The seller-email-address displayable in Seller-Profile-Page 123 may be viewable by Buyers and thus may be a different email, one where public exposure may be tolerated or desired.

In some embodiments, the Operator may select additional Seller-Data 352 to include in Seller-Profile 353. Such additional Seller-Data 352 may comprise one or more of the following: at least one seller-web-address; a means for the Seller to provide specialties, certifications, and/or licenses information of the Seller; and/or geographical-areas that the Seller may operate in. For example, and without limiting the scope of the present invention, the at least one seller-web-address may be websites independent of GUI 120 webpages and of webpages associated with the method and/or system.

In some embodiments, the means for the Seller to provide specialties, certifications, and/or licenses information of the Seller may be a portion of Seller-Profile 353 that permits the Seller to upload various files, e.g. pdf files, depicting various specialties, certifications, and/or licenses, along with a text field for the Seller to enter a short description of the various specialties, certifications, and/or licenses. When the Operator may be selecting options available to the Seller in setting up Seller-Profile 353, the Operator may select options for including specialties, certifications, and/or licenses information of the Seller.

In some embodiments, the means for the Seller to provide specialties, certifications, and/or licenses information of the Seller may be a portion of Questionnaire 300 listing out various specialties, certifications, and/or licenses categories that the Operator may make available to the Seller for the Seller to select when the Seller sets up their Seller-Profile 353. Such a listing may be by selectable by web-form using radio buttons and/or check-boxes.

With respect to the Operator selecting geographical-areas that the Seller may operate in, e.g. in a dog walking COM 100, the Operator may want to create a list of applicable geographical-areas that the Operator's particular dog walking COM 100 plans on covering (e.g. by zip code or by city or by area code, and the like), such that when the Seller is creating their Seller-Profile 353, the Seller may include in their Seller-Profile 353 the geographical-areas that the Seller services (operates in).

In some COM's 100, the geographical-areas may be actual physical mailing addresses. For example, in a personnel training COM 100, the trainer (Seller) in setting up his/her Seller-Profile 353 may want to list gym locations that the trainer trains clients (Buyers) at, and thus the Operator when answering Questionnaire 300 may make selections such that the resulting COM 100 may be capable of capturing this geographical-area information from the Seller when the Seller creates Seller-Profile 353. Additionally, in some personnel training COM's 100, the Operator in selecting to include geographical-area information as Seller-Data 352 may permit the trainer (Seller) to specify in their Seller-Profile 353 that the trainer trains clients (Buyers) in the client's homes or offices.

In some embodiments, Seller-and-Buyer-Characteristics 340 may comprise the Operator selecting Seller-Data 352 that COM 100 may require from the Seller in order for the Seller to showcase goods and/or services offered by the Seller on COM 100. Such Seller-Data 352 may comprise: at least one product-headline, at least one product-description, at least one product-image, and the price for Package-Based-pricing 352 or the price for Time-Based-Pricing 343. When the Seller may provide such Seller-Data 352, the provided Seller-Data 352 may be displayed in Seller-Profile-Page 123 and/or displayed in Seller-Web-Pages 124.

In some embodiments, Seller-and-Buyer-Characteristics 340 may comprise the Operator selecting buyer-viewable-information. The buyer-viewable-information may comprise Seller-Data 352 deemed or designated public in Seller-Profile 353 and/or Seller-Web-Pages 124. In some embodiments, the method and/or the system may have designated some selectable Seller-Data 352 fields as private and others as public (buyer-viewable-information). In some embodiments, the Operator may designate some selectable Seller-Data 352 fields as private and others as public (buyer-viewable-information). In some embodiments, Seller-Profile 353 may comprise displayable Seller-Data 352, wherein some Seller-Data 352 may be private and other Seller-Data 352 may be public. For example, a Seller SSN, some Seller addresses, phone numbers, email, and the like may be private. The entirety of Seller-Profile 353 may be viewable by the Seller; whereas only some portions of Seller-Profile 353 may be public and deemed buyer-viewable-information. The method and/or the system may notify the Seller when the Seller may be creating or editing Seller-Profile 353 which Seller-Data 352 may be private and/or which Seller-Data 352 may be buyer-viewable-information.

Continuing discussing FIG. 3(c), in some embodiments, Seller-and-Buyer-Characteristics 340 may comprise the Operator selecting a requirement that Buyers must create Buyer-Account 354 in order for Buyers to transact with Sellers on COM 100. When the Operator may select the requirement that Buyers create Buyer-Account 354, the Buyer must provide Buyer-Data 354a to COM 100 to create Buyer-Account 354. Buyer-Data 354a, for Buyer-Account 354 creation, may comprise: a buyer-email-address, a buyer-name (e.g. a username), a buyer-password, and the like.

Continuing discussing FIG. 3(c), in some embodiments, Seller-and-Buyer-Characteristics 340 may comprise the Operator selecting Return-Period 356 applicable to COM 100. Return-Period 356 may be selected from the group comprising: no returns, 30 days, 60 days, 90 days, 120 days, 6 months, one year, two years, and the like. The Operator may also be able to select whether the Buyer may be able to return for a replacement (exchange) or return for a refund, or both. In some embodiments, the Operator may select a plurality of Return-Periods 356, wherein one Return-Periods 356 may be applicable for exchanges and another Return-Periods 356 may be applicable for refunds.

Continuing discussing FIG. 3(c), in some embodiments, Seller-and-Buyer-Characteristics 340 may comprise the Operator selecting a Buyer-Minimum-Age 355 in order for the Buyer to be able to transact (e.g. buy and/or browse) in COM 100. In some embodiments, Seller-and-Buyer-Characteristics 340 may comprise the Operator selecting a minimum required age for the Seller in order for the Seller to transact (e.g. sell) in COM 100. For example, some COM's 100 may be directed to adult goods and/or services. For example, depending upon the type of COM 100, and/or location (e.g. State and/or nation) of COM 100, such minimum transaction ages may be 18, 21, 25, 65, and the like.

FIG. 3(d) may depict a block diagram of Modules 360 main category of Questionnaire 300. In some exemplary embodiments, the method must include at least two mandatory Modules 360. The at least two mandatory Modules 360 may be Search-Module 361 and Transaction-Module 362. The Buyer may need an ability to search for Sellers of COM 100 and then to buy goods and/or services being offered by the Sellers. Hence in exemplary embodiments, Search-Module 361 and Transaction-Module 362 may be mandatory Modules 360 for any COM 100 created with the method and/or system.

In some embodiments, optional Modules 360 may be selected from the group comprising: a Scheduling-Module 363, a Package-Pricing-Module 364, a Location-Management-Module 365, a Feedback-Module 366, a Media-Module 367, a Marketing-Module 368, a Buyer-Seller-Dispute-Module 369, a Digital-Delivery-Module 370, a Product-Module 371, and the like. In some embodiments, depending upon the type of COM 100 being built, some of these optional Modules 360 may be mandatory.

Modules 360 in general may be sub-routines of executable code, executable by processor 501, already written, and non-transitorily stored within memory 502. Each Module 360 may be configured to perform a particular task associated with a functional online marketplace. Not every type of Module 360 may be applicable or desirable to be included with a particular COM 100.

Each of the above named Modules 360 may be briefly described below.

In some embodiments, Search-Module 361 may allow Buyers to search for Sellers by filtering through attributes that may have been selected by the Operator. In such embodiments, Search-Module 361 may be specifically a “seller-search-module.”

In some embodiments, Transaction-Module 362 may manage financial transactions occurring on the created COM 100. In some embodiments, Transaction-Module 362 may execute payment delivery from the Buyer to an intermediary account, and then there may delivery of the good or service or some other clearly established milestone, and then Transaction-Module 362 may transfer the payment out of the intermediary account to an account specified by the Seller. The payment actually transferred to the Seller may be adjusted down to accommodate various commission structures, e.g. a commission of the Operator and/or a commission of the Staff.

Note, “account” as used in the preceding paragraph generally refers to a financial account, such as a bank account (e.g. checking and/or savings), a Paypal® financial account, and the like. In some embodiments, the intermediary account may be an account of the Staff. In some embodiments, the intermediary account may be an account of the Operator. The intermediary account may operate as an escrow account (a neutral account or a holding account).

In some embodiments, Transaction-Module 362 may also reverse payments. For example, and without limiting the scope of the present invention, if the Operator prompts the COM 100 to make a reversal; or if Buyer-Seller-Dispute-Module 369 was incorporated into COM 100 and a dispute has been initiated, then Transaction-Module 362 may facilitate a reversal of payment out of the intermediary account. If a payment has been delivered to a Seller from the intermediary account, or otherwise, and a dispute may be initiated, Transaction-Module 362 (or Buyer-Seller-Dispute-Module 369) may freeze Seller-Account 351 and request a refund from the Seller.

In some embodiments, Scheduling-Module 363 may allow Buyers to see availability of Sellers before they purchase a/the session/service. Scheduling-Module 363 may allow Sellers to efficiently schedule their time. Scheduling-Module 363 may comprise schedule conflict checking. For example, a client (Buyer) may not be allowed to book a dog walker (Seller) who already has a booking scheduled at the time and day desired by the client.

In some embodiments, Package-Pricing-Module 364, if selected, may define whether any spatial and/or temporal constraints may exist upon the sale of goods or services within the created COM 100. If Package-Pricing-Module 364 is selected to be incorporated into the created COM 100, then the Operator may select whether Package-Pricing-Module 364 may be “seat-based” or “unlimited-seating.”

In a COM 100 wherein the service was hair cutting, a particular barbershop as the Seller may indicate that their barbershop may have ten seats and enter that number as the maximum capacity when completing the seller-profile. The Operator in including Package-Pricing-Module 364 and then selecting seat-based package pricing, may have then entered a maximum capacity that the largest barbershop might have in the geographical region to be served by the given COM 100. Thus, in this example, the seat-based package pricing is both a spatial constraint and a temporal constraint, as only one person (Buyer) may occupy a limited number of barber chairs at a given point in time.

Another example, consider a personal training COM 100, a personal trainer, as the Seller, may also be seat-based, with only one seat per trainer seller, as one trainer may only train one client (the Buyer) at a time. Thus, if the Operator in completing Questionnaire 300 were creating a personal training COM 100, the Operator might select Package-Pricing-Module 364 with seat-based constraints.

In contrast, unlimited-seating may be selected for COM's 100 wherein the Seller may be able to sell goods or services largely irrespective of spatial and temporal constraints. For example, a legal services COM 100 may include Package-Pricing-Module 364 wherein unlimited-seating was selected by the Operator. A given attorney (the Seller) may not be limited by a number of chairs available in the attorney's office and thus a seat-based constraint may be ill advised for the Operator to select. In unlimited-seating the Seller may set a standard delivery time or the Buyer may specify a deadline that the Seller needs to approve. Package-Pricing-Module 364 may permit the Operator to configure such choices.

In some embodiments, Location-Management-Module 365 may permit the Operator to approve a list of physical locations where services may be rendered to Buyers. In some embodiments, Location-Management-Module 365 may permit Sellers to add locations for service rendering.

In some embodiments, Feedback-Module 366 may allow Buyers to review Sellers. In some embodiments, Feedback-Module 366 may allow Sellers to review Buyers. In some embodiments, Feedback-Module 366 may only permit reviews after a transaction is completed. In some embodiments, Feedback-Module 366 may allow for portions of reviews to be viewable online. In some embodiments, portions of a given review may be public and viewable online. In some embodiments, portions of a given review may be private and viewable only to the specific parties (the Buyer and the Seller) of a given transaction. In some embodiments, Feedback-Module 366 may comprise an ability for either party (Buyer or Seller) to comment on a given review. In some embodiments, Feedback-Module 366 may comprise an ability for either party (Buyer or Seller) to object to a given review and request Operator investigation into the given review.

In some embodiments, Media-Module 367 may permit Sellers to include media, such as audio, video, and images into seller-web-pages. In some embodiments Media-Module 367 may permit Sellers to embed links to media outside of the COM 100, e.g. a link to a YouTube® video.

In some embodiments, Marketing-Module 368 may permit sellers to embed marketing information associated with Seller-Profile 353 of the given COM 100 in other websites that may be distinct from the COM 100. Thus, Seller may advertise their Seller-Profile 353 associated with the COM 100 on other third party websites and platforms, including websites that the Seller may own and/or control. Such marketing information may comprise information typical of a business card, such as business name, contact name, phone number, website, email, fax, and the like. In such embodiments, Server-Module 520 may generate code (e.g. short code) and deliver the code to the Seller so that the seller may embed the code in the third part websites and platforms. The code when executed by a web browser may render the marketing information into a viewable format on the third party web sites and platforms.

In some embodiments, Buyer-Seller-Dispute-Module 369 may provide a forum for Buyers and Sellers to attempt to settle any dispute between the Buyer and the Seller. In some embodiments, either or both the Buyer and the Seller may timely dispute a transaction. If timely, progress of any payments may be halted. The pending transaction may then be put into an escalation queue. The Operator may then be notified that there is a new dispute by an automatically generated notification (e.g. email and/or text message) by the method/system. Such an automatic notification may be triggered by the Buyer or Seller submitting a dispute. The Operator may then select from several scenarios, which may initiate a series of appropriate notifications (e.g. email) and automatically process funds to the Buyer and/or the Seller, based on decisions of the Operator. For example, a no-show of the Seller might prompt the Buyer to initiate a dispute, wherein an email may be automatically sent to the Seller notifying the Seller who did not show up for a personal training session, that the Seller will not be paid and no-show's will not be tolerated in the service and to the buyer an apology and full refund through the payment system. In some embodiments, the Operator's role of facilitating a resolution of a buyer-seller dispute may be performed by the Staff.

In some embodiments, Digital-Delivery-Module 370 may facilitate delivery of virtual items from the Seller to the Buyer. In some embodiments, Digital-Delivery-Module 370 may facilitate an exchange of virtual items between Sellers and Buyers. Virtual items may comprise documents, e.g. various reports or other written work products that the Buyer may have ordered from the Seller. Virtual items may comprise documents, e.g. pdf files.

In some embodiments, Product-Module 371 may be used to configure characteristics of goods to be sold within COM 100. When Product-Module 371 may be selected to be incorporated into COM 100, the Operator may then select from an established list of fields to include for when the Seller establishes their Seller-Profile 353 and/or Seller-Web-Pages 124. The selected fields may result in an overall ability of the Seller to describe and present their goods to be sold within COM 100. In some embodiments, the Operator including Product-Module 371 may not necessarily be limited to Good-COM's 322, but may also be used with Services-COM's 323.

For example, in a personal training COM 100, the good provided may the “personal trainer,” i.e. the Seller. The Operator might select Product-Module 371 with the following applicable fields to be selected, such that when the Seller completes their Seller-Profile 353, these fields must be completed, i.e. these fields may request Seller-Data 352:
Headline (e.g. tagline)
Name (of the trainer)
Gender (of the trainer)
Description (of trainer's services)
Image (e.g. photograph of the trainer)
Price per hour
   Then such a created COM 100 may only accept goods (services) of this type when a given Seller (personal trainer) may be establishing their seller-profile and/or seller-web-pages.

Note, the ability of the Operator to select a given module for inclusion into a given COM 100 may depend upon the type of COM 100 selected by the Operator. For example, in some embodiments, if the Operator selects Goods-COM 322 as the type of COM 100, then the Operator may not be presented with Scheduling-Module 363 nor Location-Management-Module 365 as Module 360 options to include in COM 100.

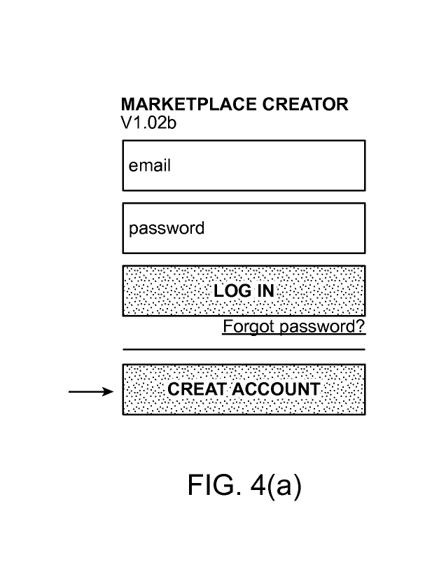

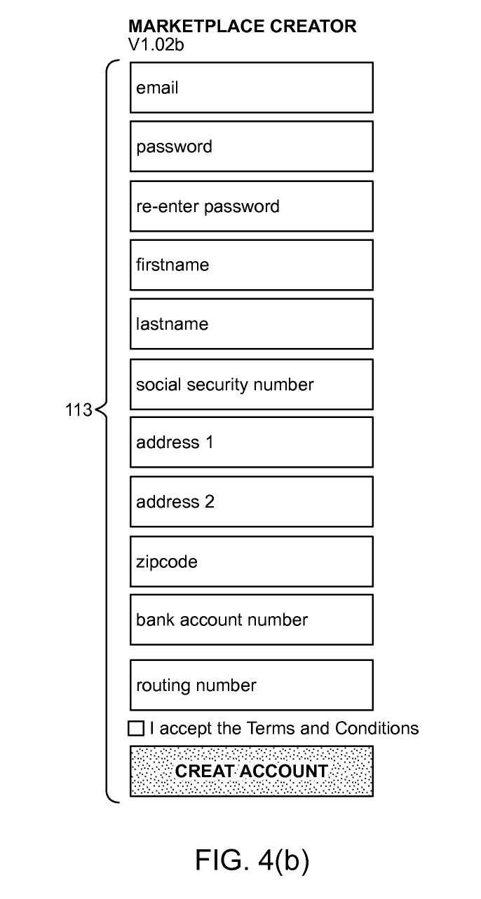

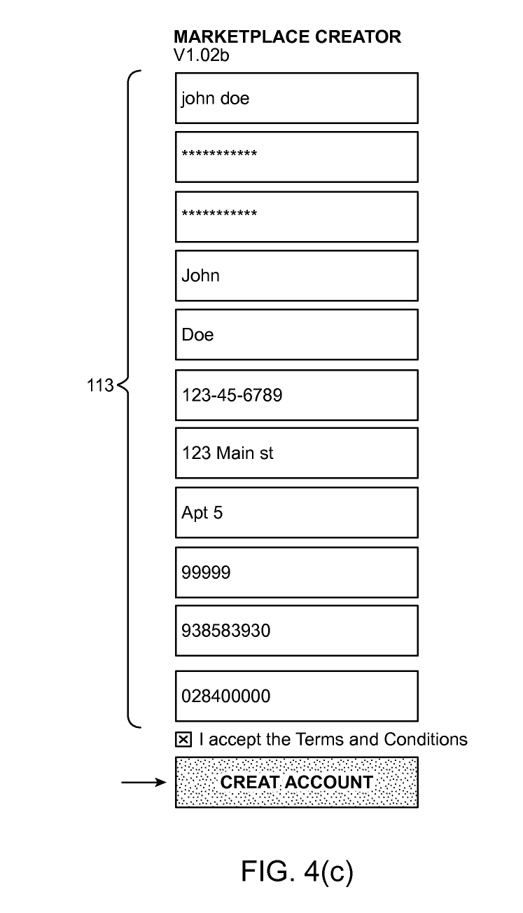

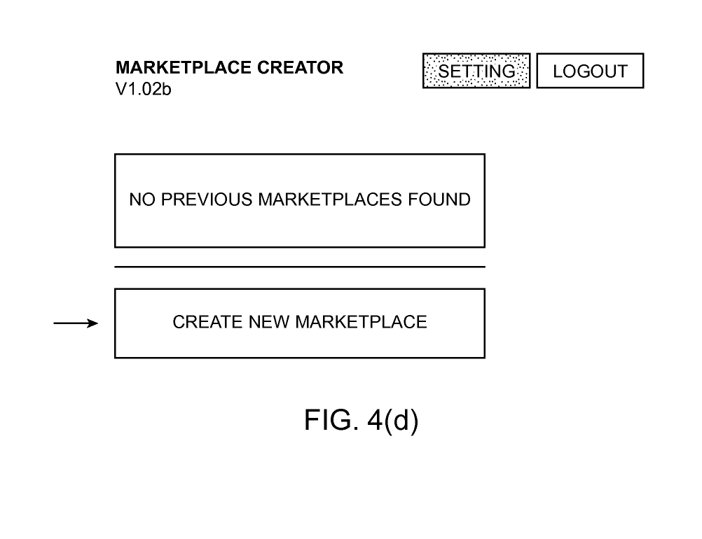

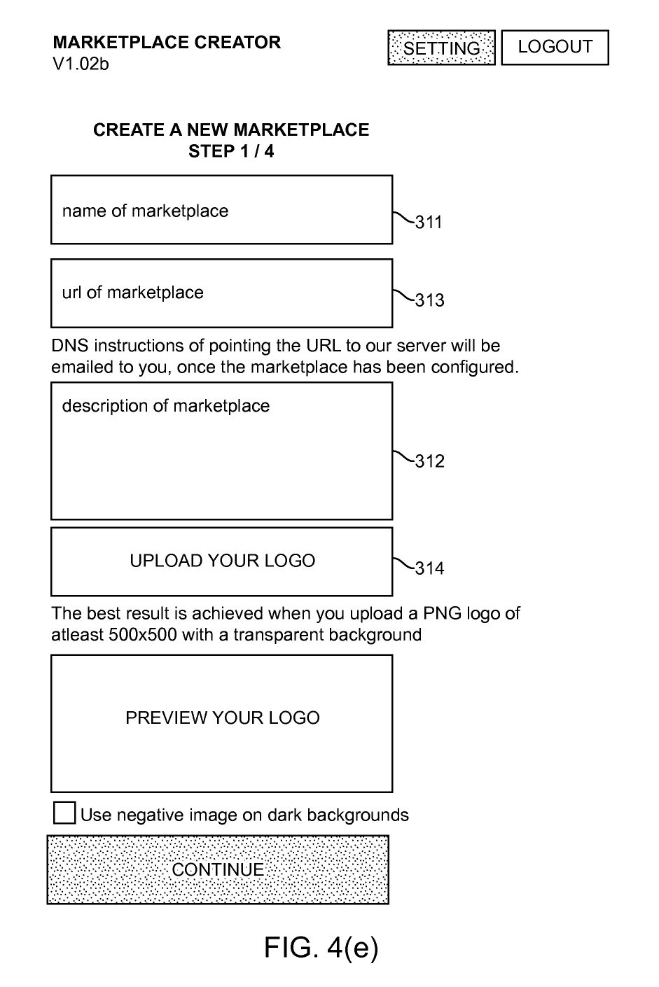

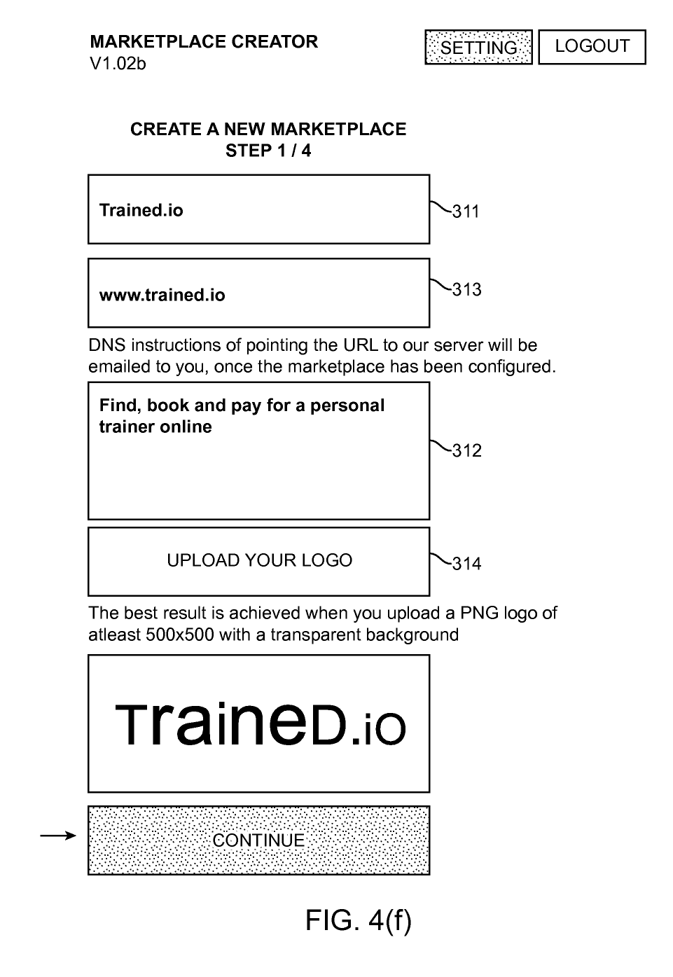

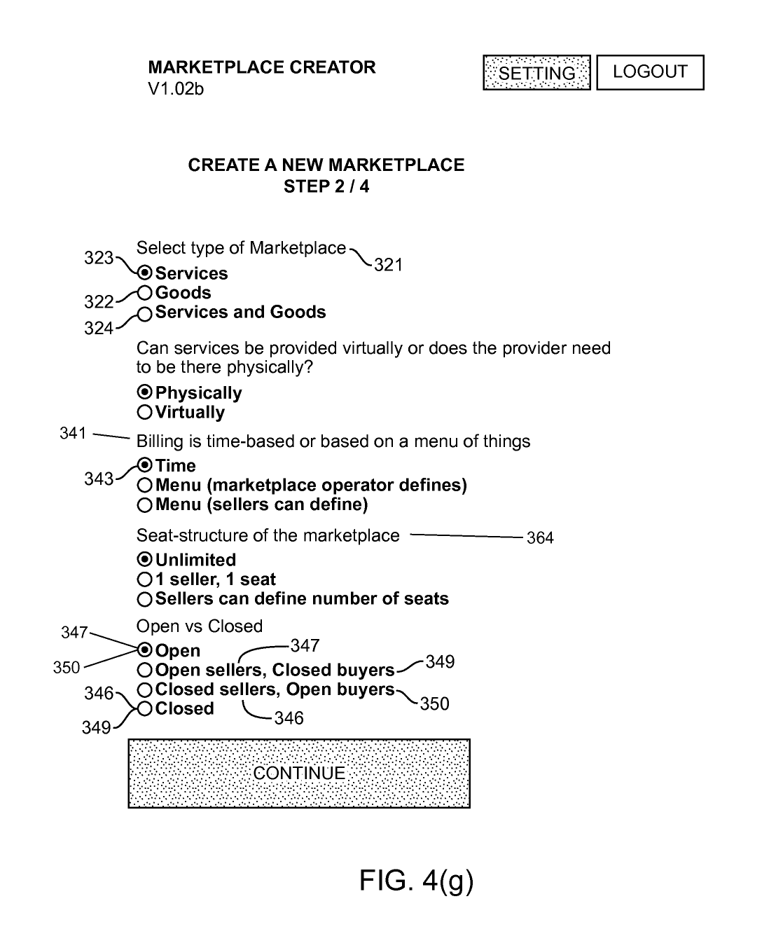

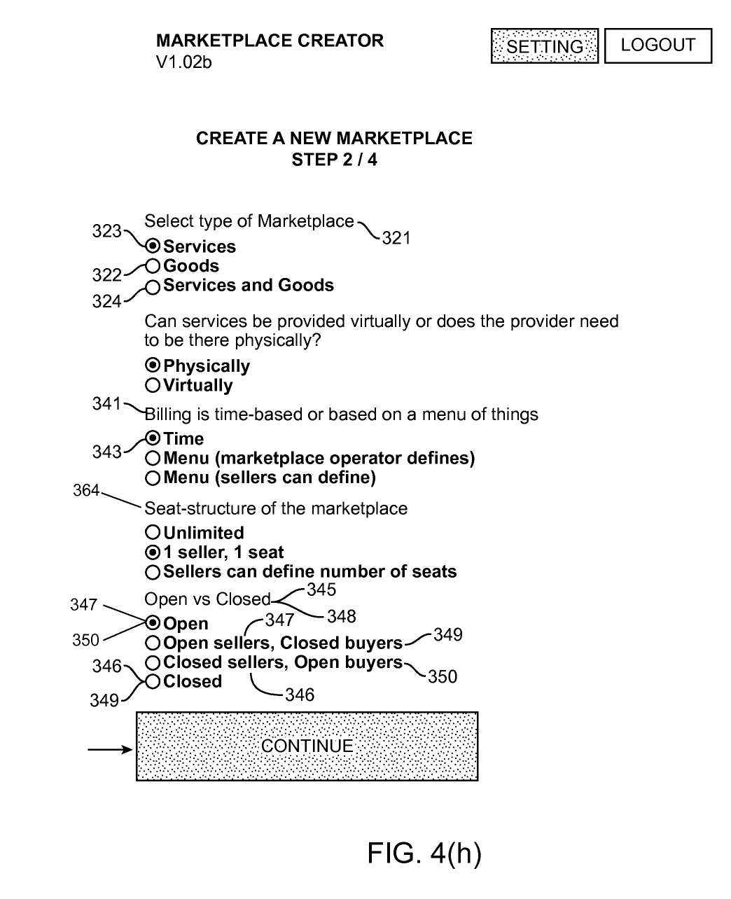

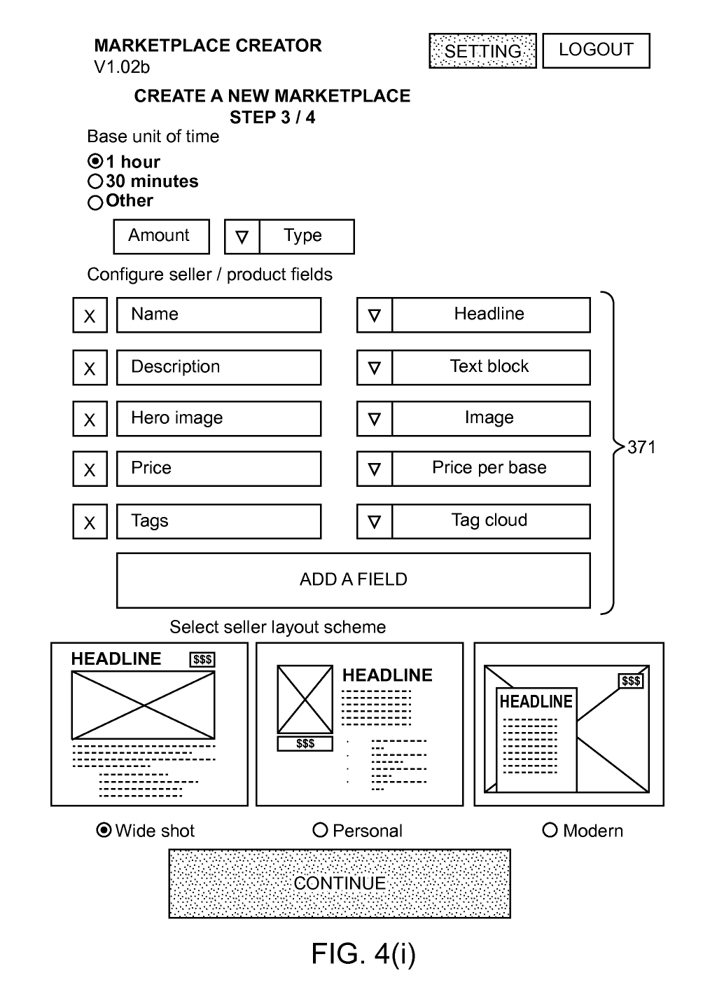

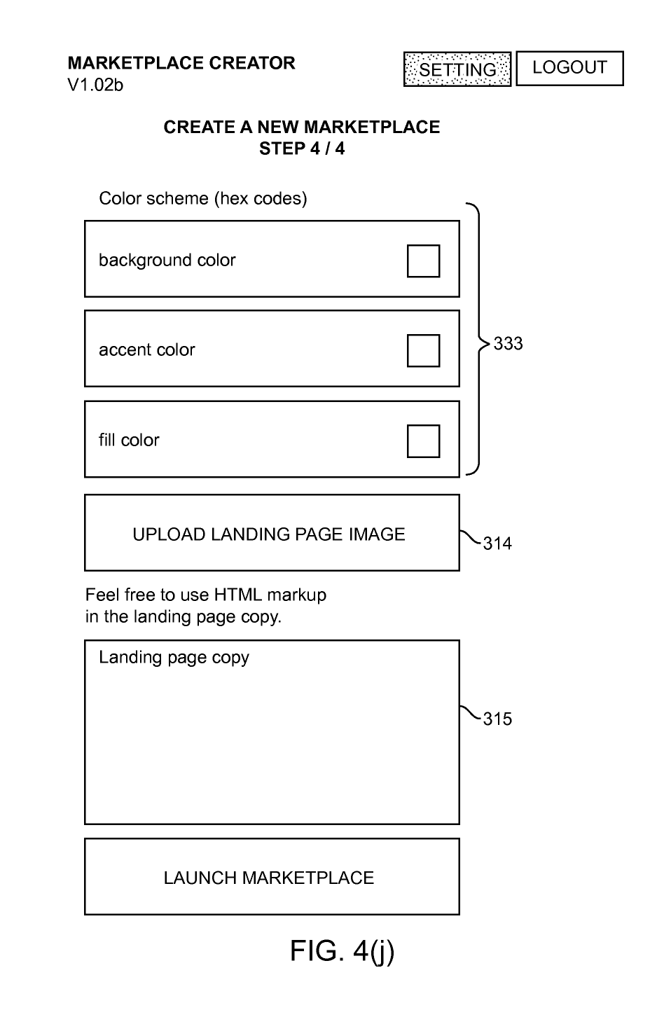

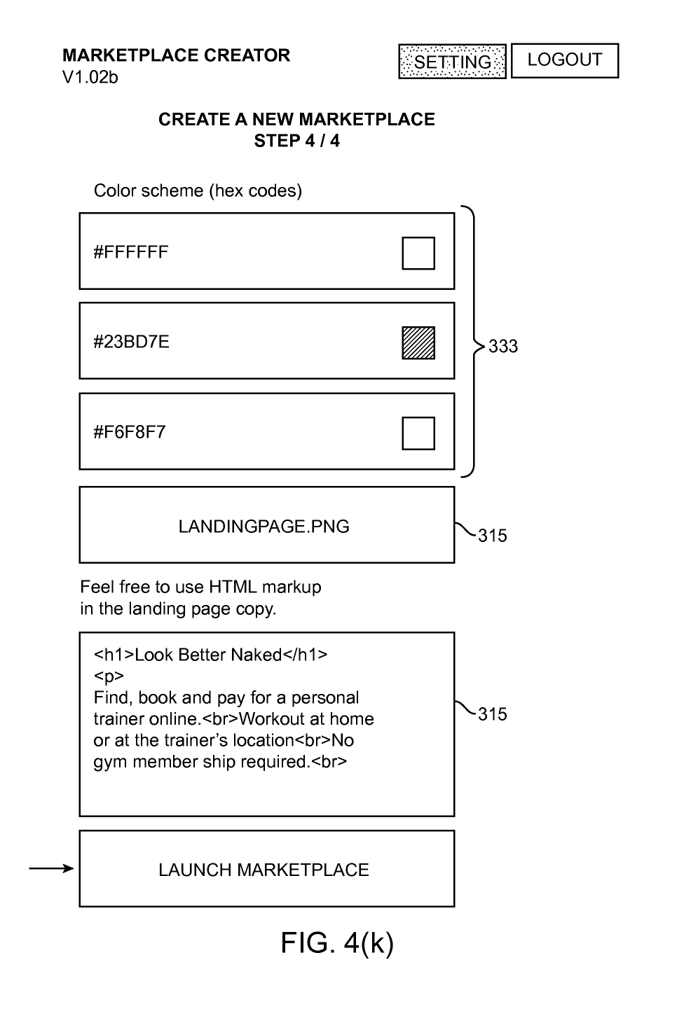

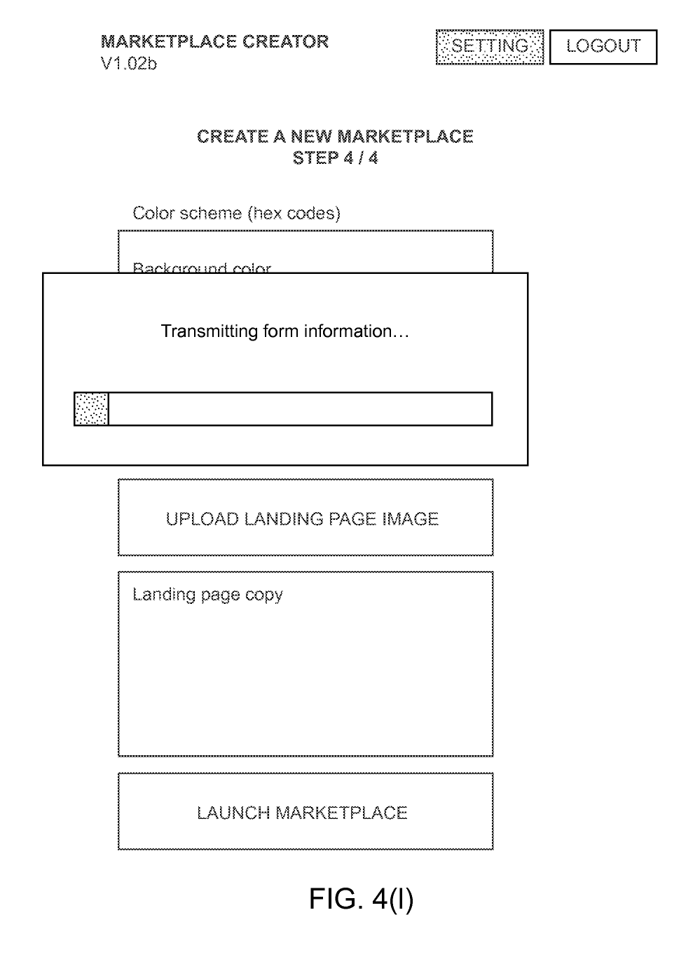

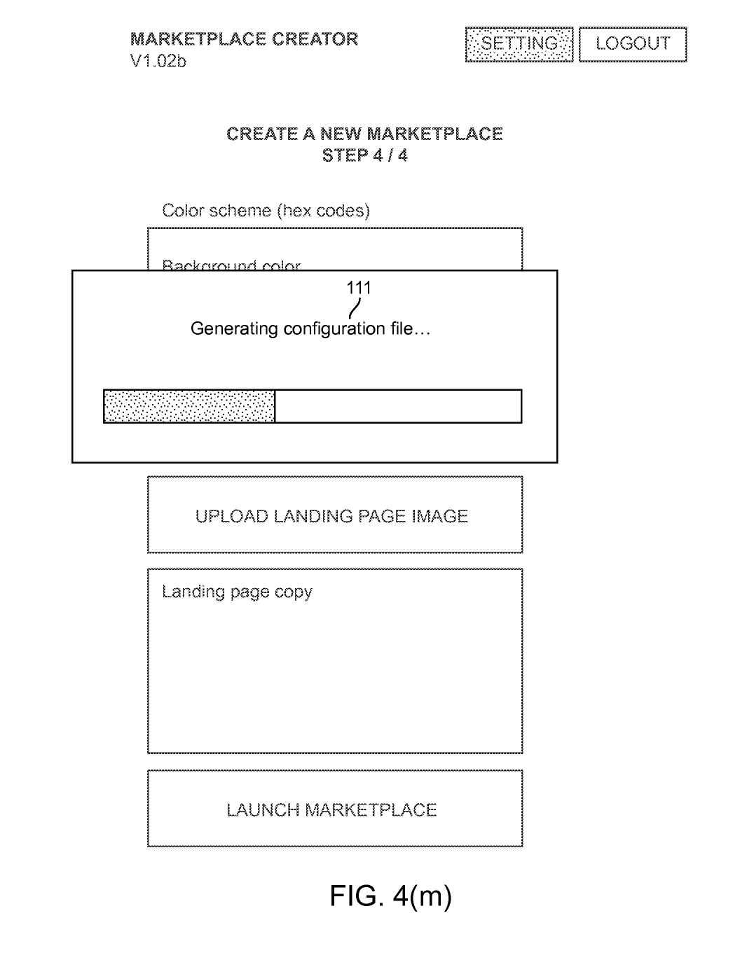

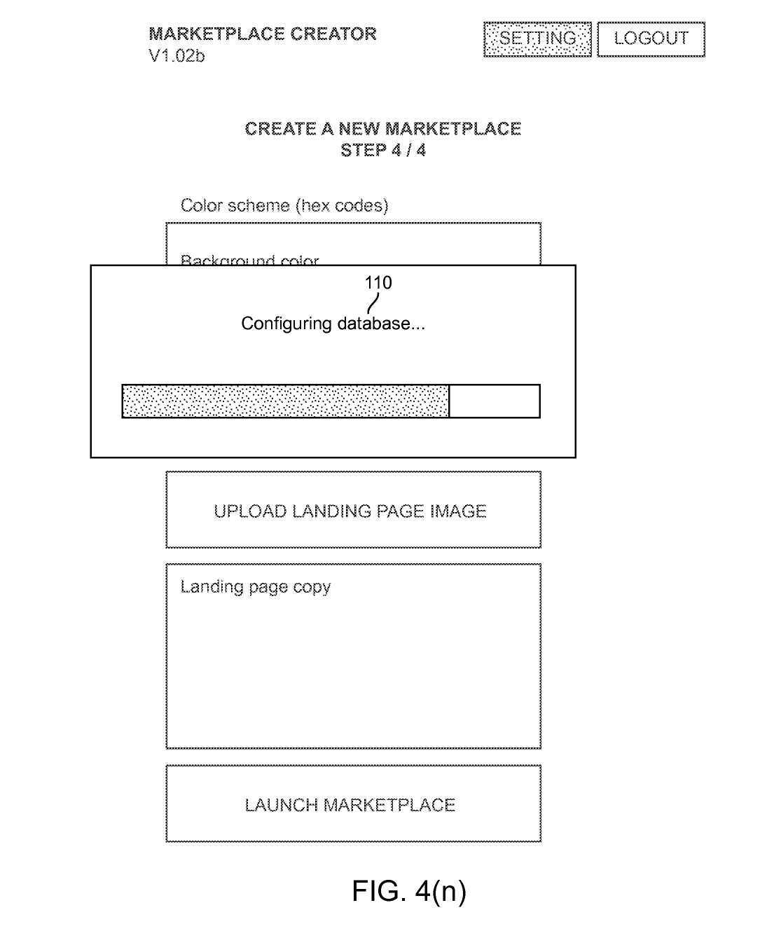

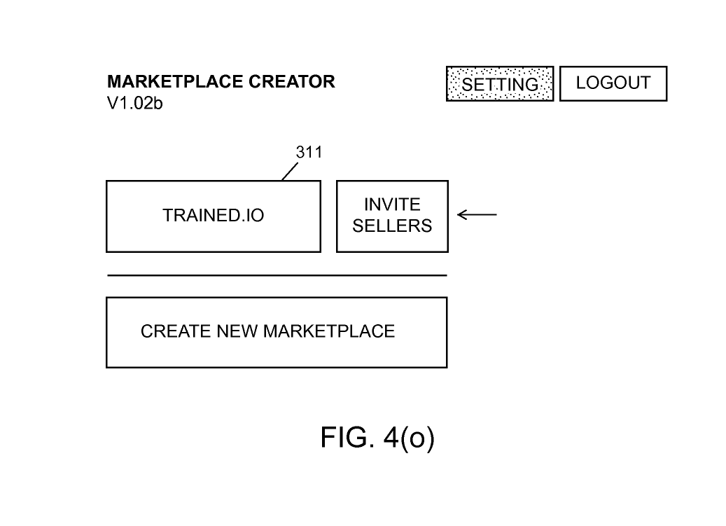

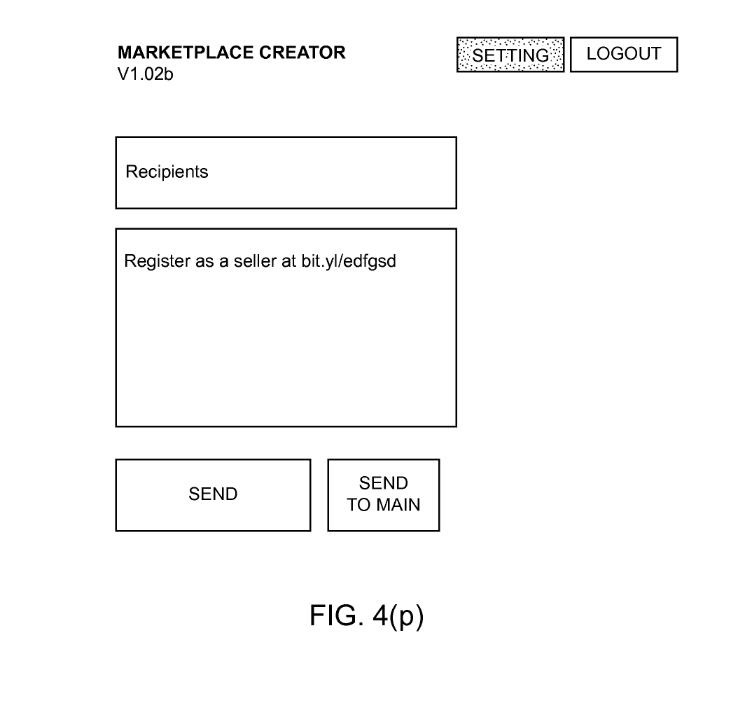

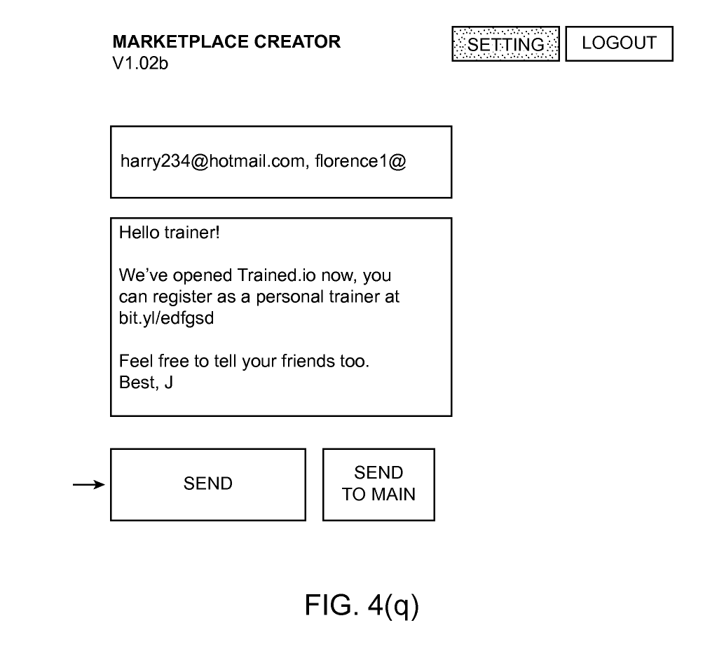

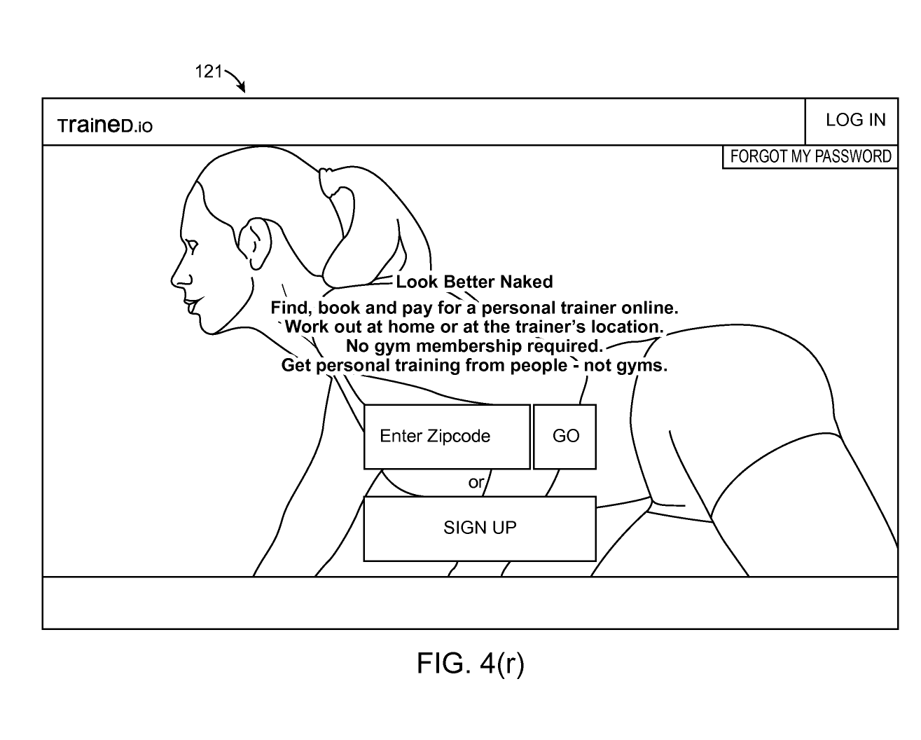

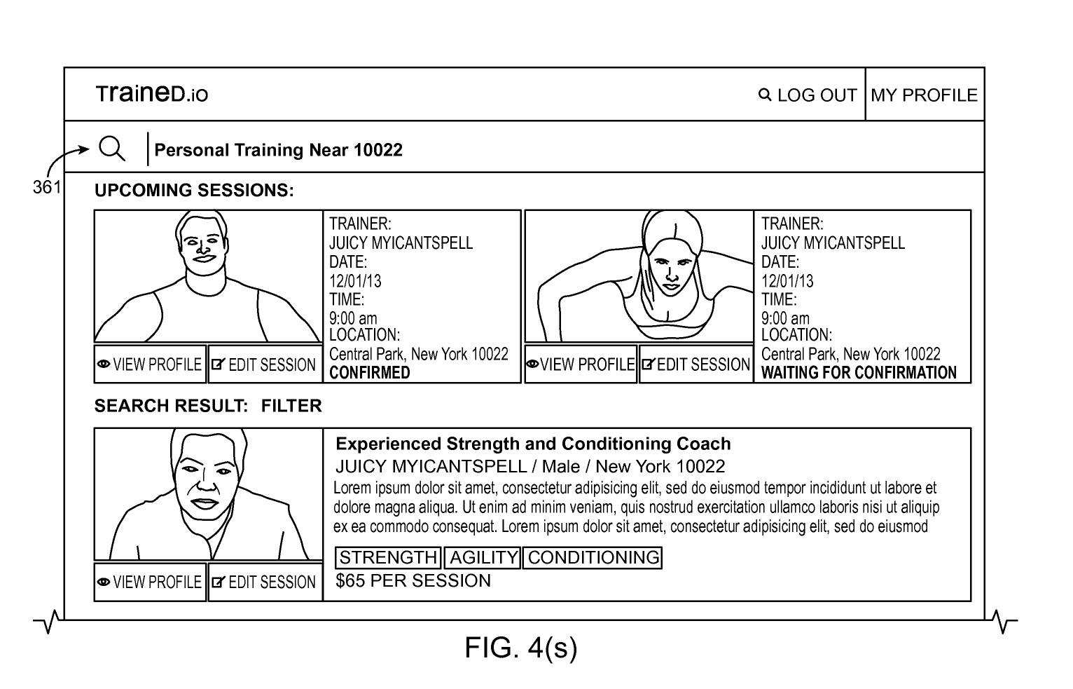

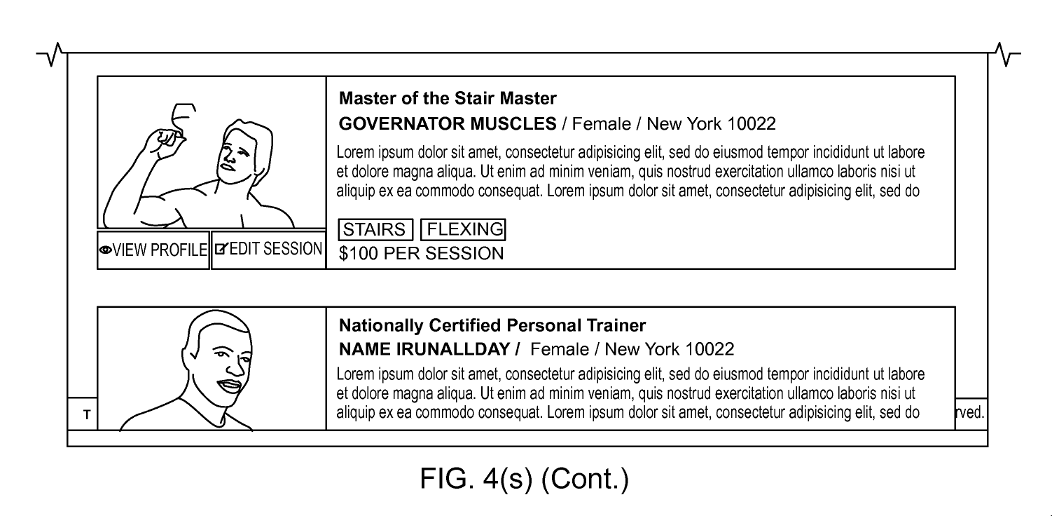

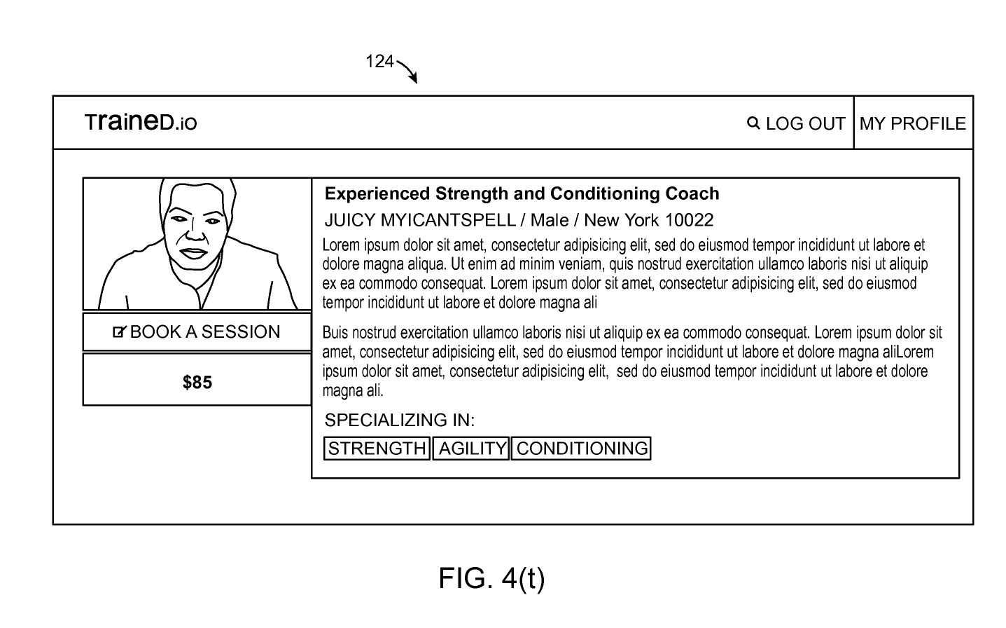

A FIG. 4 series of figures may depict a series of exemplary sequential graphical user interface webpage images which may depict how the Operator progresses through Questionnaire 300 to generate COM 100 directed towards a personal trainer marketplace as an example of COM 100 which may be created with the method.

FIG. 4(a) may depict an Operator-Login-Webpage, wherein the Operator-Login-Webpage may be a webpage associated with the method. From this Operator-Login-Webpage a prospective Operator may click a button to take the Operator to a webpage to enter in Operator-Data 113 to create Operator-Account 112a.

FIG. 4(b) may depict an Operator-Account-Creation-Webpage, wherein the Operator-Account-Creation-Webpage may be a webpage associated with the method. Here a prospective Operator may enter in various Operator-Data 113 and click a button to create Operator-Account 112a. For example, in some exemplary embodiments, such Operator-Data 113 may comprise: email of the Operator, password of the Operator, first name of the Operator, last name of the Operator, social security number of the Operator, address fields for the Operator, bank account number of the Operator, routing number for the bank of the Operator, and the like.

FIG. 4(c) may depict the Operator-Account-Creation-Webpage, wherein the Operator-Account-Creation-Webpage may be a webpage associated with the method and wherein the Operator-Account-Creation-Webpage may be populated with Operator-Data 113. Upon the Operator entering in required Operator-Data 113 and clicking a submit button, e.g. a “Create Account” button, then Operator-Account 112a may be created.

FIG. 4(d) may depict a Portal-Webpage wherein the Operator may access Questionnaire 300, wherein the Portable-Webpage may be a webpage associated with the method. If the Operator has never created a COM 100, then the Operator may click a button taking the Operator to Questionnaire 300, such as clicking a button, “Create New Marketplace.”

FIG. 4(e) may depict a webpage of Questionnaire 300 wherein the Operator may provide Operator-Supplied-Data 310. For example, and without limiting the scope of the present invention, the Operator may provide Name-of-COM 311, COM-URL 313, Description-of-COM 312, and Operator-Supplied-Graphical-Elements 314. For example, Operator-Supplied-Graphical-Elements 314 may be graphic file depicting a logo of COM 100 to be generated.

FIG. 4(f) may depict the webpage of FIG. 4(e) wherein the Operator may have provided Operator-Supplied-Data 310. In some exemplary embodiments, the Operator may be able to preview the graphic file depicting the logo, wherein the graphic file depicting the logo may be a subcomponent of Operator-Supplied-Graphical-Elements 314.

FIG. 4(g) may depict a webpage of Questionnaire 300 wherein the Operator may make selections of Predetermined-Options 320, with default selections displayed. For example, and without limiting the scope of the present invention, the Operator may select a COM-Type 321. The Operator may also select some Seller-and-Buyer-Characteristics 340, such as a Seller-Payment-Scheme 341 (e.g. selecting Time-Based-Pricing 343). The Operator may also select some Seller-and-Buyer-Characteristics 340, such as a Type-of-Seller 345 (as either Open 347 or Closed 346). The Operator may also select some Seller-and-Buyer-Characteristics 340, such as a Type-of-Buyer 348 (as either Open 350 or Closed 349). Open may be Public.

In some embodiments, Package-Pricing-Module 364 may have been included, and the Operator may then need to select the type of seating, with the default selection being “Unlimited.” For example, in FIG. 4(h) the Operator may have selected, “1 seller, 1 seat,” as the appropriate selection for a personal training COM 100.

In some embodiments, the Operator may also select whether the services, if a Services-COM 323 has been selected, may be provided “Physically” or “Virtually.” If the service may require that the Seller and the Buyer be physically present to render the services, then the Operator would select “Physically,” as may be the case in a personal training COM 100, i.e. “Physically” may be location-dependent. Whereas, “Virtually” may be location-independent.

FIG. 4(h) may depict the webpage of FIG. 4(g) wherein the Operator may have made selections of Predetermined-Options 320, such as selecting “1 seller, 1 seat,” for Package-Pricing-Module 364.

FIG. 4(i) may depict a webpage of Questionnaire 300 wherein the Operator may make selections of features to be included within a Product-Module 371. The Operator may decide which data fields of Product-Module 371 a Seller would need to complete. For example, and without limiting the scope of the present invention, the Operator may include such data fields as: Name, Description, Hero image, Price, Tags, Headline, Text block, Image, Price per base, Tag cloud, and the like. Such data fields may be for accepting Seller-Data 352.

In some embodiments, the Operator may also decide a layout for Seller-Profile-Page 123 and/or Seller-Web-Pages 124. For example, and without limiting the scope of the present invention, the Operator may select layouts from a “Wide shot,” a “Personal,” or a “Modern” layout structure for Seller-Profile-Page 123 and/or Seller-Web-Pages 124, wherein various Seller-Data 352 may be displayed.

FIG. 4(j) may depict a webpage of Questionnaire 300 wherein the Operator may provide Operator-Supplied-Graphical-Elements 314 and/or wherein the Operator may select some Theme 333 selections to be applied to a look and feel of a generated COM 100. The Operator may also provide Descriptive-Copy-of-COM 315, note Descriptive-Copy-of-COM 315 may include HTML markup language as well as plain text information. For example, and without limiting the scope of the present invention, Operator-Supplied-Graphical-Elements 314 may be a graphic file depicting an image for display on COM-Homepage 121. In some embodiments, after such a graphic file may be uploaded, the image may be previewed by the Operator.

For example, and without limiting the scope of the present invention, in addition to uploading a graphic file for Operator-Supplied-Graphical-Elements 314, the Operator may also select some Theme 333 selections, such as a background color for GUI 120, an accent color for GUI 120, and a fill color for GUI 120.

FIG. 4(k) may depict a webpage of Questionnaire 300 wherein the Operator may have provided Operator-Supplied-Graphical-Elements 314, Descriptive-Copy-COM 315, and/or wherein the Operator may have selected some Theme 333 selections to be applied to a look and feel of a generated COM 100.

Once Questionnaire 300 may be completed by the Operator, the Operator may click a submit button, such as “Launch Marketplace” button, wherein the Answers and Selections of Questionnaire 300 may be transmitted to Server-Module 520.

FIG. 4(l) may depict a webpage notification message that a webpage has or may be in the process of transmitting completed Questionnaire 300 information (Answers and Selections) to Server-Module 520. Additional notification messages may be displayed, such as that the transmission was completed successfully, or that an error may have occurred during transmission. In some embodiments, the Operator may save progress in completing Questionnaire 300, such that Operator may complete Questionnaire at a later date.

FIG. 4(m) may depict a webpage notification message that Server-Module 520 may be constructing a Configuration-File 111 from the transmitted completed Questionnaire 300. Server-Module 520 may receive completed Questionnaire 300 and via Generation-Script 521, may process the Answers and Selections to generate Configuration-File 111. Additional notification messages may be displayed, such as that generating Configuration-File 111 was completed successfully, or that an error may have occurred during generation of Configuration-File 111.

FIG. 4(n) may depict a webpage notification message that Server-Module 520 may use generated Configuration-File 111 to aid in configuring Database 110 of COM 100. Additional notification messages may be displayed, such as that configuring Database 110 was completed successfully, or that an error may have occurred during configuration of Database 110.

FIG. 4(o) may depict an Admin-Portal-Webpage for entry into Admin-Dashboard 122 of GUI 120, wherein the Operator may manage the generated COM 100. Once a COM 100 may be generated via the method, Name-of-COM 311 may display as a selectable button in the Admin-Portal-Webpage, that the Operator may select to enter Admin-Dashboard 122.

FIG. 4(p) may depict a feature of Admin-Dashboard 122, wherein the Operator may have a means to notify prospective Sellers that the generated COM 100 may now be ready to be populated with Sellers. Such a notification means may be email and/or text messaging.

FIG. 4(q) may depict the feature of Admin-Dashboard 122, wherein the Operator may have drafted a notification to a prospective Seller that the generated COM 100 may now be ready to be populated with Sellers.

FIG. 4(r) may depict COM-homepage 121 of a generated COM 100. From COM-homepage 121, prospective Sellers and prospective Buyers may click an account creation button/link, e.g. such a button may be a “Sign Up” button. From COM-homepage 121, the Operator, Sellers, and Buyers may click login button/link, e.g. such a button may be a “Log In” button. COM-homepage 121 may display at COM-URL 313.

FIG. 4(s) may depict a COM-webpage that a Buyer may be directed to after entering the generated COM 100 via the COM-homepage 121, wherein the COM-webpage may present the Buyer with Search-Module 361 and brief summaries of various Seller-Profiles 353. This COM-webpage may be a subcomponent of GUI 120. Seller-Data 352 displayed on this COM-webpage may be buyer-viewable-information.

FIG. 4(t) may depict Seller-Web-Page 124 and/or Seller-Profile-Page 123 of a particular Seller within the generated COM 100.

Having disclosed the method for generating COM 100, this disclosure now turns to disclosing the system for generating COM 100, wherein the system may comprise various components, wherein the components may use the method as described above. In some exemplary embodiments, the system may comprise Server 500, Server-Module 520, Questionnaire 300, Generation-Script 521, and Configuration-File 111. Each of these five components may be discussed below.

Server 500 may be in communication with WAN 201. Note, although FIG. 2 may only depict one Server 500, it should be obvious that the method and the system may include a plurality of such Servers 500.

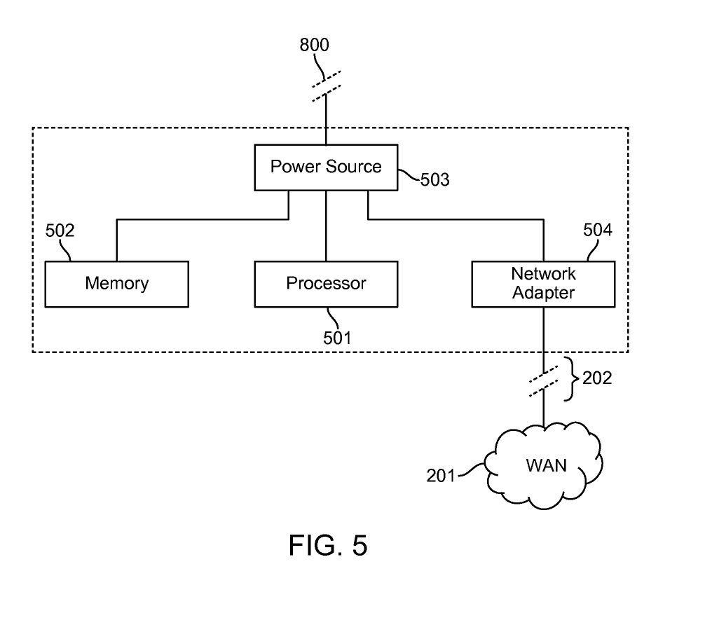

FIG. 5 may depict the main hardware components of server 500, as a block diagram, wherein the server facilitates creating COM 100 and maintaining the created COM 100. In some embodiments, in terms of main hardware components, Server 500 may comprise: Processor 501, Memory 502, Network-Adapter 504, Power-Source 503, and the like.

Processor 501 may be a main hardware component of Server 500 that controls functionality of Server 500. Data inputs and command instructions from Electronic-Devices 210 and through Network-Adapter 504 may be relayed through Processor 501. In an exemplary embodiment, Processor 501 may instruct Network-Adapter 504 to communicate with Electronic-Devices 210 across WAN 201.

In some embodiments, Memory 502 may be where data (e.g. of Database 110), Configuration-File 111 and executable code (e.g. Server-Module 520, Generation-Script 521, Modules 360) of the method may be non-transitorily stored. Memory 502 may comprise various hard-drives and/or other memory hardware devices which may be configured to non-transitorily store data, Configuration-File 111, and executable code of the method. Processor 501 may access data, Configuration-File 111, and/or executable code stored non-transitorily in Memory 502 for communication to Electronic-Devices 210. Processor 501 may access Memory 502 to record, modify, or delete data and/or Configuration-File 111 stored within Memory 502. Data stored in Memory 501 may be communicated through Network-Adapter 504 via Processor 501.

In some embodiments, Network-Adapter 504 may be a component of Server 500 that may communicate with Electronic-Devices 210, e.g. across WAN 201, through an external network connection. Network-Adapter 504 may be in communication with WAN 201, which may be wireless, wired, or a combination of wireless and wired connections.

For example, and without limiting the scope of the present invention, in some exemplary embodiments, Server 500 may be an IBM® POWER Server 770 Gen 7, a HP® ProLiant Server DI-360, a Dell® PowerEdge Server C2100, or any server capable of running Node.js® through a Linux, Unix, Windows®, Mac OS® or other similarly modern and robust operating system. Node.js® may be a software platform that may be used to build scalable network applications. Node.js® may utilize JavaScript® as its scripting language. Node.js® may be a server-side implementation which may sit on top of Googleas V8 JavaScript® engine.

In some exemplary embodiments, the operating system in use on Server 500 may be an Ubuntu® distribution of the Linux OS. In some embodiments, the operating system in use on Server 500 may be any operating system capable of being configured to run Node.js®, which may include, but may not be limited to, Unix, Windows®, Mac OS®, or other distributions of Linux.

Server-Module 520 may be executable code running on Server 500. Server-Module 520 may be non-transitorily stored within Memory 502 of Server 500. Server-Module 520 may serve many functions. Many of these Server-Module 520 functions have been noted above. Some of these Server-Module 520 functions may be as follows: Server-Module 520 may web-serve Questionnaire 300. Server-Module 520 may receive completed Questionnaire 300 (and process via Generation-Script 521). Server-Module 520 may generate COM 100 based on the defining of necessary parameters and instructions found in Configuration-File 111. Once a given COM 100 may be generated, Server-Module 520 may execute User-Transactions between Users 900. Server-Module 520 may direct executed User-Transactions to be non-transitorily stored within Database 110. Server-Module 520 may listen for web requests, respond to web requests, and perform time-based tasks that may be independent of web requests, such as CRON jobs. Once a given COM 100 may be generated, Server-Module 520 may be listen for web requests for COM-URL 313 and may respond to such requests by displaying GUI 120.

As noted above, Questionnaire 300 may be an interactive-web-form served by Server-Module 520 to the Operator. The Operator may access Questionnaire 300 from a variety of Electronic Devices 210 (across WAN 201), from either a web-browser or in some embodiments an installed mobile app running on Electronic-Device 210. The details of Questionnaire 300 may be depicted in the FIG. 3 series of figures and have been discussed above.

Generation-Script 521 may process answers and selections from the Operator in completing Questionnaire 300 to produce Configuration-File 111. Generation-Script 521 may be executable code running on Server 500. Generation-Script 521 may be non-transitorily stored within Memory 502 of Server 500. Generation-Script 521 may be a subroutine of Server-Module 520.

Configuration-File 111 may be generated from Generation-Script 521 processing completed Questionnaire 300. Configuration-File 111 may define parameters necessary to generate COM 100. Configuration-File 111 may be non-transitorily stored within Memory 502 of Server 500. In some embodiments, Configuration-File 111, may be a data component of Database 110. In some embodiments, Configuration-File 111 may be edited and updated, wherein the updated-configuration-file may be used to generate an updated COM 100. The Operator and/or the Staff may update Configuration-File 111. The Operator may update Configuration-File 111 via an interactive questionnaire within Admin-Dashboard 122.

In some embodiments, Server-Module 520 may generate COM 100 by Server-Module 520 executing Configuration-File 111. As noted above, COM 100 may comprise: GUI 120, Database 110, Configuration-File 111, and two mandatory Modules 360 (e.g. Search-Module 361 and Transaction-Module 362).

In some embodiments, the system may also comprise additional elements. In some embodiments, the system may also comprise Electronic-Devices 210. In some embodiments, the system may further comprise the Operator. In some embodiments, the system may further still comprise all of Users 900, including the Sellers, the Buyers, and the Staff. See FIG. 2, which may depict each of these additional embodiments of the system.

In some embodiments, the method and/or the system may have been developed using (and updates may use) CoffeeScript® for server-side programming (e.g. of Server-Module 520), which may compile into JavaScript® to be run in the Node.js® environment.

In some embodiments, on the client side, the method and/or the system may have been developed using (and updates may use) a combination of CoffeeScript®, which compiles into JavaScript® for execution, SASS which may compile into CSS for the browser to implement style-sheets, and Jade® which may compile into HTML structure.

A method and a system for generating (forming, building, crating) a variety of distinct and different COMs has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A system for generating a custom-online-marketplace, comprising:
(a) a server in communication with a wide-area-network;
(b) a server-module running on the server, wherein the server-module is non-transitorily stored within memory of the server;
(c) a questionnaire, wherein the questionnaire is an interactive-web-form and an operator accesses the questionnaire via an electronic-device in communication with the wide-area-network;
(d) a generation-script of the server-module receiving answers and selections from the operator in response to the questionnaire; and
(e) a configuration-file, wherein the configuration-file is generated by the generation-script processing the answers and the selections from the questionnaire; wherein the configuration-file defines parameters necessary to generate the custom-online-marketplace; and wherein the configuration-file is non-transitorily stored within the memory of the server;
(f) wherein the server-module generates the custom-online-marketplace by the server-module executing the configuration-file, wherein the custom-online-marketplace comprises:
the configuration-file;
a graphical-user-interface, wherein the graphical-user-interface displays at a uniform-resource-locator received from the operator and wherein the graphical-user-interface is accessible by a user navigating to uniform-resource-locator, wherein users interact with the custom-online-marketplace via the graphical-user-interface;
a database, wherein the database non-transitorily stores data of the database on the memory of the server, wherein the data comprises: user-accounts, including an operator-account; session-data, including user-transactions; and the configuration-file;
wherein the server-module handles web requests made by users interacting with the graphical-user-interface; wherein the server-module executes user-transactions between users; and wherein the server-module non-transitorily stores executed user-transactions within the database.

2. The system according to claim 1, wherein the users comprise operators, sellers, buyers, and/or staff;
wherein the operators are entities who initiate generation the custom-online-marketplace via the system, wherein operators are responsible for marketing the custom-online-marketplace, for finding sellers for the custom-online-marketplace, and for finding buyers for the custom-online-marketplace;
wherein the sellers are entities offering goods and/or services on the custom-online-marketplace for the buyers to purchase;
wherein the buyers are entities that purchase or browse for goods and/or servicers offered by the sellers on the custom-online-marketplace; and
wherein the staff are entities associated with execution and maintenance of the system.

3. The system according to claim 2, wherein the questionnaire comprises questions soliciting operator-supplied-data, questions prompting the operator to select predetermined-options, questions prompting the operator to select seller-and-buyer-characteristics, and questions prompting the operator to select at least two mandatory modules to incorporate into the custom-online-marketplace.

4. The system according to claim 3, wherein the operator-supplied-data comprises a name of the custom-online-marketplace, a description of the custom-online-marketplace, and the uniform-resource-locator; and wherein the operator-supplied-data optionally comprises operator-supplied-graphical-elements and/or descriptive-copy for the custom-online-marketplace.

5. The system according to claim 3, wherein the predetermined-options comprises selecting a type of custom-online-marketplace, wherein the type of custom-online-marketplace is selected from the group consisting of a goods custom-online-marketplace, a services custom-online-marketplace, and a goods and services custom-online-marketplace.

6. The system according to claim 3, wherein the predetermined-options comprises selecting an operator-commission-scheme, wherein the operator-commission-scheme is selected from the group consisting of a percentage-of-price, a fixed-rate, and a combination of percentage-of-price and fixed-rate.

7. The system according to claim 3, wherein the predetermined-options comprises selecting a transaction-type that is applicable to the custom-online-marketplace, wherein the transaction-type is selected from the group consisting of a one-time-transaction, recurring-transactions, and either the one-time-transaction or recurring-transactions.

8. The system according to claim 3, wherein the predetermined-options comprises selecting a theme from a finite list of themes presented to the operator in the questionnaire; wherein the selected theme is applied to the graphical-user-interface, wherein the selected theme governs a look and feel of the graphical-user-interface.

9. The system according to claim 3, wherein the seller-and-buyer-characteristics comprises selecting a seller-payment-scheme that is applicable to the custom-online-marketplace, wherein the seller-payment-scheme is selected from the group consisting of package-based-pricing, time-based-pricing, and a combination of package-based-pricing and time-based-pricing.

10. The system according to claim 9, wherein the operator sets a unit for the package-based-pricing or the operators permits the seller to determine the units for the package-based-pricing.

11. The system according to claim 10, wherein the operator permits the seller to determine a price for the units for the package-based-pricing.

12. The system according to claim 10, wherein the operator selects a minimum-price for the units for the package-based-pricing; and/or wherein the operator selects a maximum-price for the units for the package-based-pricing.

13. The system according to claim 9, wherein the time-based-pricing comprises a price per a unit-of-time.

14. The system according to claim 13, wherein the operator selects the unit-of-time, wherein the unit-of-time is selected from the group consisting of seconds, minutes, hours, days, weeks, bi-monthly, months, bi-annually, and annually.

15. The system according to claim 13, wherein the operator permits the seller to determine the price.

16. The system according to claim 9, wherein the operator selects a price-step-rule, wherein the price-step-rule forces the seller to determine a price for the package-based-pricing in specified increments of a currency or forces the seller to determine a price for the time-based-pricing in specified increments of the currency.

17. The system according to claim 3, wherein the seller-and-buyer-characteristics comprises:
selecting a type-of-seller, wherein the type-of-Seller is either open to the public or closed to the public; and
selecting a type-of-buyer, wherein the type-of-buyer is either open to the public or closed to the public.

18. The system according to claim 3, wherein the seller-and-buyer-characteristics comprises:
selecting a seller-account requirement, wherein the operator selecting a requirement that sellers must create the seller-account in order for sellers to create a seller-profile on the custom-online-marketplace, wherein when the operators selects the requirement of the seller-account, the seller must provide seller-data to the custom-online-marketplace to create the seller-account, wherein the seller-data comprises at least one seller-email-address, at least one seller-name, and at least one seller-password; and
selecting a buyer-account requirement, wherein the operator selecting a requirement that buyers must create the buyer-account in order for buyers to transact with sellers on the custom-online-marketplace, wherein when the operators selects the requirement of the buyer-account, the buyer must provide buyer-data to the custom-online-marketplace to create the buyer-account, wherein the buyer-data comprises a buyer-email-address, a buyer-name, and a buyer-password.

19. The system according to claim 18, wherein the seller-data further comprises at least one unique-identifier, seller-banking-information, and at least one seller-address.

20. The system according to claim 18, wherein the seller-and-buyer-characteristics comprises selecting further seller-data that the custom-online-marketplace requires from the seller in order for the seller to obtain the seller-profile for use on the custom-online-marketplace, wherein the further seller-data comprises: at least one seller-headline, at least one seller-description, at least one seller-profile-image, the at least one seller-email-address, and at least one seller-phone-number.

21. The system according to claim 20, wherein the seller-and-buyer-characteristics comprises selecting additional seller-data to include in the seller-profile, wherein the additional seller-data comprises one or more of the following: at least one seller-web-address; a means for the seller to provide specialty, certification, and/or license information of the seller; and/or geographical-areas that the seller operates in.

22. The system according to claim 20, wherein the seller-and-buyer-characteristics comprises selecting additional seller-data that the custom-online-marketplace requires from the seller in order for the seller to showcase goods and/or services offered by the seller on the custom-online-marketplace, wherein the additional seller-data comprises: at least one product-headline, at least one product-description, at least one product-image, and a price for a package-based-pricing or a time-based-pricing; wherein when the seller provides such additional seller-data the provided additional seller-data is displayed in the seller-profile and/or displayed on a seller-web-page.

23. The system according to claim 22, wherein the seller-and-buyer-characteristics comprises selecting buyer-viewable-information, wherein the buyer-viewable-information comprises seller-data deemed public by the operator included in the seller-profile and/or the seller-web-page.

24. The system according to claim 3, wherein the seller-and-buyer-characteristics comprises selecting a return-period applicable to the custom-online-marketplace, wherein the return-period is selected from the group consisting of: no returns, 30 days, 60 days, 90 days, 120 days, 6 months, one year, and two years.

25. The system according to claim 3, wherein the seller-and-buyer-characteristics comprises selecting a minimum required age for the buyer to be able to transact in the custom-online-marketplace and/or the selecting a minimum required age for the seller in order for the seller to transact in the custom-online-marketplace.

26. The system according to claim 3, wherein the at least two mandatory modules are a search-module and a transaction-module; wherein optional modules are selected from the group consisting of: a scheduling-module, a package-pricing-module, a location-management-module, a feed-back-module, a media-module, a marketing-module, buyer-seller-dispute-module, a digital-delivery-module, and a product-module.

27. The system according to claim 2, wherein the graphical-user-interface comprises:
a custom-online-marketplace-home-page, wherein the custom-online-marketplace-home-page is a webpage, wherein the custom-online-marketplace-home-page is primary entry point into the graphical-user-interface of the custom-online-marketplace for users; wherein the custom-online-marketplace-home-page is accessible by users navigating to the second-internet-protocol-address or the navigating to the URL forwarded to the second-internet-protocol-address; wherein the custom-online-marketplace home-page comprises at least one user log-in link and/or at least one new user account creation link.
a seller-profile-page, wherein the seller-profile-page displays seller-data associated with a seller-profile; and
an admin-dashboard; wherein the admin-dashboard is accessible by the operator logging into the operator-account; wherein the operator has options to select and view statistics associated with the custom-online-marketplace; wherein the operator has option to select and view completed transactions and pending transactions; wherein the admin-dashboard displays the operator's answers and selections to the questionnaire, and wherein the operator has an ability to edit the answers and the selections, such that an updated-configuration-file is created, wherein the server-module executes the updated-configuration-file to generate an updated-custom-online-marketplace; and
a uniform look and feel applied to the graphical-user-interface, wherein the uniform look and feel is supplied by the operator-supplied-graphical-elements, the selected theme, or a default look and feel if no operator-supplied-graphical-elements are supplied and no theme is selected.

28. The system according to claim 27, wherein the graphical-user-interface comprises a seller-web-page; or wherein the seller-profile-page comprises the seller-web-page, wherein the seller-web-page displays seller-data describing the seller's goods and/or services for sale.

29. The system according to claim 1, wherein the system further comprises the operator-account, wherein the operator must supply operator-data to the server-module to create the operator-account, wherein the operator-data comprises: an operator-email-address, an operator-name, and an operator-password; wherein creation of the operator-account is required before the operator accesses the questionnaire; and wherein the operator-data is data that is non-transitorily stored within database.

30. A non-transitory computer-readable-medium including codes executable by a processor, for:
(a) receiving answers and selections of a questionnaire, wherein the questionnaire is displayed in an interactive-web-form, wherein the questionnaire is completed by an operator;
(b) generating a configuration-file from a generation-script, wherein the generation-script processes the answers and the selections of the questionnaire, wherein the configuration-file defines parameters necessary to create the custom-online-marketplace;
(c) generating the custom-online-marketplace by a server-module executing the configuration-file, wherein the custom-online-marketplace comprises:
the configuration-file;
a graphical-user-interface, wherein the graphical-user-interface displays at a uniform-resource-locator received from the operator and wherein the graphical-user-interface is accessible by a user navigating to the uniform-resource-locator, wherein users interact with the custom-online-marketplace via the graphical-user-interface;
a database, wherein the database non-transitorily stores: user-accounts, including an operator-account; session-data, including user-transactions; and the configuration-file;
wherein the server-module handles web requests made by users interacting with the graphical-user-interface; wherein the server-module executes user-transactions between users; and wherein the server-module non-transitorily stores executed user-transactions within the database.
